(19) United States
(12) Patent Application Publication
(10) Pub. No.: US 2021/0278347 A1
(43) Pub. Date: Sep. 9, 2021

(54) MACHINE DIRECTION LINE FILM INSPECTION

(71) Applicant: 3M INNOVATIVE PROPERTIES COMPANY, St. Paul, MN (US)

(72) Inventors: Steven P. Floeder, Shoreview, MN (US); Nathaniel S. Rowekamp, Inver Grove Heights, MN (US); Xin Yu, Woodbury, MN (US); James A. Masterman, Lake Elmo, MN (US); Ian A. Edhlund, Seneca, SC (US); Mark E. Flanzer, Acton, MA (US); Scott P. Daniels, Woodbury, MN (US); Matthew V. Rundquist, Woodbury, MN (US); Jeffrey P. Adolf, Rochester, MN (US)

(21) Appl. No.: 16/326,635

(22) PCT Filed: Sep. 1, 2017
(86) PCT No.: PCT/US2017/049841

§ 371 Date: Feb. 19, 2019

Related U.S. Application Data
(63) Continuation-in-part of application No. PCT/US2017/049841, filed on Sep. 1, 2017.
(60) Provisional application No. 62/382,608, filed on Sep. 1, 2016.

(51) Int. Cl. G01N 21/89; G01N 21/892; G01N 21/896

(52) U.S. Cl. CPC G01N 21/8901; G01N 2021/8908; G01N 21/896; G01N 21/8921

(57) ABSTRACT

Techniques are described for inspection of films in order to detect Machine Direction Line (“MDL”) defects. An example system comprises a light source configured to provide a source of light rays, directed to a film product so that the light rays are incident to a surface of the film product at a non-perpendicular angle of incidence. An image capturing device is configured to generate an image of the film product by capturing a level of light intensity of the light rays exiting the film product in a plurality of image areas, each image area representing a line imaged across the film product that is perpendicular to a direction of manufacture of the film product. An image processing device is configured to process the image of the film product to provide an indication of the detection of one or more machine direction line (MDL) defects in the film product.

### RELATED APPLICATION

This application claims the benefit of U.S. Provisional Application Ser. No. 62/382,608, filed Sep. 1, 2016, the entire contents of which is incorporated herein by reference in its entirety.

### TECHNICAL FIELD

The disclosure relates to detecting machine direction lines (“MDLs”) in manufactured films.

### BACKGROUND

Manufacturing processes for making various types of films, such as transparent polyester films, involve manufacturing the films in a long continuous sheet, referred to as a web. The web itself is generally a material having a fixed width in one direction (“crossweb direction”) and either a predetermined or indeterminate length in the orthogonal direction (“downweb direction”). During the various manufacturing processes used in making and handling the web, the web is conveyed along a longitudinal axis running in parallel to the length dimension of the web, and perpendicular to the width dimension of the web.

Various means are used to form the web, such as film dies, and to convey the web during the manufacturing process, such as rollers or other types of support mechanisms. In various instances, these mechanisms can introduce or create a defect in the film resulting in an imperfection in the film thickness that appears as a line or as a bump having a relatively short dimension relative to the width of the web, but that can exist in a direction along the longitudinal axis of the web for some, most, or all of the length of the web. These imperfections are sometimes referred to as Machine Direction Lines (“MDLs”) because they appear as lines or bumps in the surface of that film that run in a direction generally parallel the direction used to transport the web during the manufacturing of the film.

### SUMMARY

In general, techniques are described herein for inspection of films in order to detect Machine Direction Line (“MDL”) defects in the film. In various examples, the MDL defects are defects in the surface of the film that extend in the downweb (longitudinal axis) direction of the film and often have relatively small dimensions in the crossweb direction, such as in a range of from about 0.1 to about 10 millimeters. However, the deviation in film thickness or caliper for the MDL defects can be extremely small, such as in a range of from about 10 to about 1000 nanometers. This level of crossweb variation in the film surface is extremely difficult to detect using known film inspection techniques. However, these defects, for example when a film is used as an enhancement film for a display, such as a film used in a computer monitor or a mobile phone, create visually discernable distortion(s) in the display that are noticeable to the human eye when viewing the display or screen. As recognized herein, in order to provide high quality film for use as a film for displays or other uses where minor distortions in the film can be problematic, it is important to be able to detect MDL type of defect in the film before the film is released or sold for use in these applications. Further, as recognized herein, the ability to consistently detect MDL defects can be used to help a film manufacturer locate a source or cause of these MDL defects, and to allow the manufacturing process to be repaired or otherwise adjusted to eliminate the MDL defects in subsequently manufactured webs of film. In addition, as recognized herein the capability to detect MDL defects having variation in the sub-micron range is an effective tool for use in evaluation of the suitability of new raw materials used in the film manufacturing process, and for evaluating process improvements that are being considered for use in the production of films and film products. The example implementations and techniques described herein allow consistent detection of MDL defects causing surface defects in films that have variation in the sub-micron range. These example implementations and techniques also allow for quantitative measures to be made and tracked relative to these MDL defects, thus providing a means for detecting, monitoring, and for making improvements in the manufacturing of these film and film products.

In general, as used herein, the terms “film” and “film product” refer to a material formed of a sheet having a nominal thickness, a predetermined width dimension, and a predetermined or indefinite length dimension. In various examples, the film or film product is formed of a single layer of one type of material, the single layer of material being transparent or semi-transparent. However, examples of types of film and film products are not limited to a single layer film or a film comprising just one type of material, and other forms of film are contemplated by use of the terms “film” and “film product” as described in this disclosure. As recognized herein, the MDL defects present in a film change what is referred to as the “optical caliper” of the film along the position of the film where the MDL defect or defects exist. Optical caliper refers to the properties of light waves as the light waves pass through a transparent or semi-transparent film, including the properties of the light waves as the light waves enter the film at a first surface of the film, pass through the film itself, and exit the film at the surface of the film adjacent to the first surface of the film, generally in reference to the thickness dimension of the film. The example implementations and techniques described herein provide imaging of film products and image processing techniques that provide detection and quantification of machine direction lines in the film products that represent sub-micron variations in the film's optical caliper. In various implementations, machine direction lines caused by caliper variations as small as about 100 nanometers can be detected using the example implementations and techniques described herein.

As one example, the disclosure is directed to a system for inspecting a film product, the system comprising a light source operable to (configured to) provide a source of light rays, the system operable to direct the light rays to a film product so that the light rays are incident to a surface of the film product at an angle of incidence, the light rays operable to pass through the film product and to be refracted at an angle of refraction when exiting the film product; an image capturing device operable to generate an image of the film product by capturing a level of light intensity of the light rays exiting the film product in a plurality of image areas, each image area representing a line imaged across the film product, the line having a direction that is perpendicular to a direction of manufacture of the film product, the image capturing device comprising an image sensing array operable to capture, as an electronic signal, variations in a level of light intensity received at the image sensing array for each of the plurality of image areas to generate an image of the film product, the variations in level of light intensity received by the image sensing array resulting from variations in the angle of refraction of the light rays exiting the film product in the image area of the film product where the light rays exited the film product; and an image processing device operable to process the image of the film product to provide an indication of a detection of one or more machine direction line (MDL) defects in the film product.

As another example, the disclosure is directed to a method comprising transmitting light from a point light source through a film product, the light refracted at an angle of refraction when passing through and then exiting the film product; directing the refracted light, using a lens, to a focal point comprising an edge of an opening of an aperture, and blocking, by the edge, a portion of the refracted light from passing through the opening while allowing the remaining portion of the refracted light to pass though the opening of the aperture and be received at an image sensing array when the angle of refraction of the light received at the focal point is an expected angle of refraction; capturing, by an image sensing array, an electronic signal corresponding to a variation of a level of light intensity received by the image sensing array for each of a plurality of image areas of the film product, each of the plurality of image areas corresponding to an imaged line on the film product having a direction that is perpendicular to a direction of manufacturing used to manufacture the film product, the variations in level of light intensity received by the image sensing array resulting from variations in the angle of refraction of the light exiting the film product in the plurality of image areas of the film product; and analyzing the image to detect the presence of one or more machine direction lines in the film product.

As another example, the disclosure is directed to a method of calibrating a film product inspection system comprising transmitting, from a point light source, without passing the light through a film product, the light to a reflective surface at an angle that corresponds to an expected angle of refraction, the light reflected at an angle of refraction equal to an expected angle of refraction the light would be refracted at if the light passed through and then exited a film product to generate a refracted light exiting the film at the expected angle of refraction; directing, by a reflective surface and without passing the reflected light through a film product, the light to a focal point behind a lens; positioning an edge at the focal point so that a predetermined portion of the reflected light is blocked by the edge, and a remaining portion of the reflected light passes the edge through an opening adjacent to the edge; and adjusting the position of the edge so that the remaining portion of the reflected light passing the edge through the opening in the aperture is received at an image sensing array in a level that generates an electronic signal in image sensing array corresponding to a predetermined level of light intensity.

In another example, the disclosure is directed to a method for capturing image data associated with a film product, the method comprising: moving, by a conveying device, at least a portion of a film product comprising a single layer of film having a width dimension and a length dimension in a first direction parallel to the length dimension, the first direction parallel to a direction of manufacturing used to manufacture the film product; imaging, by an image capturing device, the portion of the film product while moving the portion of the film product, wherein imaging the portion of the film product comprises capturing a level of light intensity of light rays exiting the film product in each of a plurality of image areas within the portion of the film to generate image data for each of the image areas, each of the image area comprising an image line; and analyzing, by processing circuitry, the image data for each of the image areas in real time to detect the presence of one or more machine direction lines in the film product.

In another example, the disclosure is directed to a system for capturing image data associated with a film product, the system comprising: a conveying device configured to move at least a portion of the film product in a first direction parallel to a length dimension of the film product, the first direction parallel to a direction of manufacturing used to manufacture the film product, the portion of the film product comprising a single layer of film having a width dimension that is perpendicular to the length dimension; an image capturing device configured to image the portion of the film product while the portion of the film product is moving in the first direction, the image capturing device configured to image the portion of the film product by capturing a level of light intensity of light rays exiting the film in each of a plurality of image areas within the portion of the film product to generate image data for each of the image areas, each of the image area comprising an image line; an image processing device comprising processing circuitry configured to analyze the image data for each of the image area in real time to detect the presence of one or more machine direction lines in the film product.

### BRIEF DESCRIPTION OF DRAWINGS

FIG. 1 is a block diagram illustrating an overview of a system for manufacturing a film product, and testing the manufactured film product for MDL defects in accordance with one or more example implementations and techniques described in this disclosure.

FIG. 2 is a diagram illustrative of a top view of an example portion of a film product comprising a test sample in accordance with one or more example implementations and techniques described in this disclosure.

FIG. 3 is a diagram providing a perspective view of an example imaging system for imaging a test sample in accordance with one or more example implementations and techniques described in this disclosure.

FIG. 4A is a diagram providing a cross-web view of a test sample illustrating refraction of light rays passing through the test sample in accordance with one or more example implementations and techniques described in this disclosure.

FIG. 4B is a diagram of a test sample illustrating refraction of light rays in accordance with one or more example implementations and techniques described in this disclosure.

FIG. 5 is a block diagram of a side-view of an example imaging system operable to provide imaging of a test sample in accordance with one or more example implementations and techniques described in this disclosure.

FIG. 6 illustrates an example image and examples of graphical information that can be generated from imaging a test sample in accordance with one or more example implementations and techniques described in this disclosure.

FIG. 7 is a flowchart illustrating one or more example methods in accordance with various techniques described in this disclosure.

FIG. 8 is a flowchart illustrating one or more example methods in accordance with various techniques described in this disclosure.

FIG. 9 is a block diagram illustrating an overview of various example systems for manufacturing a film product, and testing the manufactured film product for MDL defects in accordance with one or more example implementations and techniques described in this disclosure.

FIG. 10 is a conceptual diagram illustrative of a top view of an example portion of a film product illustrating an imaging technique in accordance with one or more example implementations and techniques described in this disclosure.

FIG. 11 is a conceptual diagram illustrative of a top view of an example portion of a film product illustrating another imaging technique in accordance with one or more example implementations and techniques described in this disclosure.

FIG. 12A illustrates an example image that can be generated from imaging a film product in accordance with one or more example implementations and techniques described in this disclosure.

FIG. 12B illustrates an example of graphical information that may be generated from imaging a film product in accordance with one or more example implementations and techniques described in this disclosure.

FIG. 13 illustrates another example of graphical information that can be generated from imaging a film product in accordance with one or more example implementations and techniques described in this disclosure.

FIG. 14 is a flowchart illustrating one or more example methods in accordance with various techniques described in this disclosure.

FIG. 15 is a flowchart illustrating one or more example methods in accordance with various techniques described in this disclosure

The drawings and the description provided herein illustrate and describe various examples of the inventive methods, devices, and systems of the present disclosure. However, the methods, devices, and systems of the present disclosure are not limited to the specific examples as illustrated and described herein, and other examples and variations of the methods, devices, and systems of the present disclosure, as would be understood by one of ordinary skill in the art, are contemplated as being within the scope of the present application.

### DETAILED DESCRIPTION OF ILLUSTRATIVE EMBODIMENTS

As noted above, MDL defects can be problematic. For example, when present on films that are intended for use in display devices such as computer monitors and cellular phones, MDL defects cause distortions to the images being viewed on these display devices that can be distracting to a user. However, due to the very small optical caliper distortion of these MDL defects, conventional techniques, such as measuring the thickness of the film or film product, are not adequate to detect these small dimensional imperfections created by the MDL defects. The example implementations and techniques disclosed herein allow for detection and quantification of MDL defects having sub-micron dimensions.

The example implementations and techniques described herein utilize a modified Schlieren approach to imaging a sample portion of a film to detect and quantify any MDL defects that might exist in the test sample. In various example implementations, a point light source transmits light through the film, reflects the light off a spherical mirror, transmits the light through the film a second time, and converges the light again to a spot in the plane of an image capturing device, such as camera lens aperture. The camera aperture is arranged to then act as a knife edge, allowing a portion of the light rays that are not refracted by MDL defects in a particular portion of the test sample to be blocked, while allowing a remaining portion of these not refracted light rays pass through an opening in the aperture and be provided to an image sensing array operable to convert the light rays into image data. In some instances, the aperture is operable to block a larger portion of the light rays that are refracted by the MDL defect or defects in a particular portion of the test sample, preventing a larger portion, or in some instances all of these light rays from reaching an image sensing array. In other instances, the camera aperture is arranged to allow more of the light rays to pass through the aperture when the light rays are refracted by the MDL defect or defects.

By separating the light rays being passed through the film of the test sample, as further described herein, an image of the test sample can be captured, and by using one or more image processing techniques, an extremely high sensitivity to very subtle optical caliper variations in the film caused by MDL defects can detected and quantified. Various example implementations and techniques for detection and quantification of MDL defects having dimensions in the sub-micron range are further described below with respect to the figures and description as provided herein.

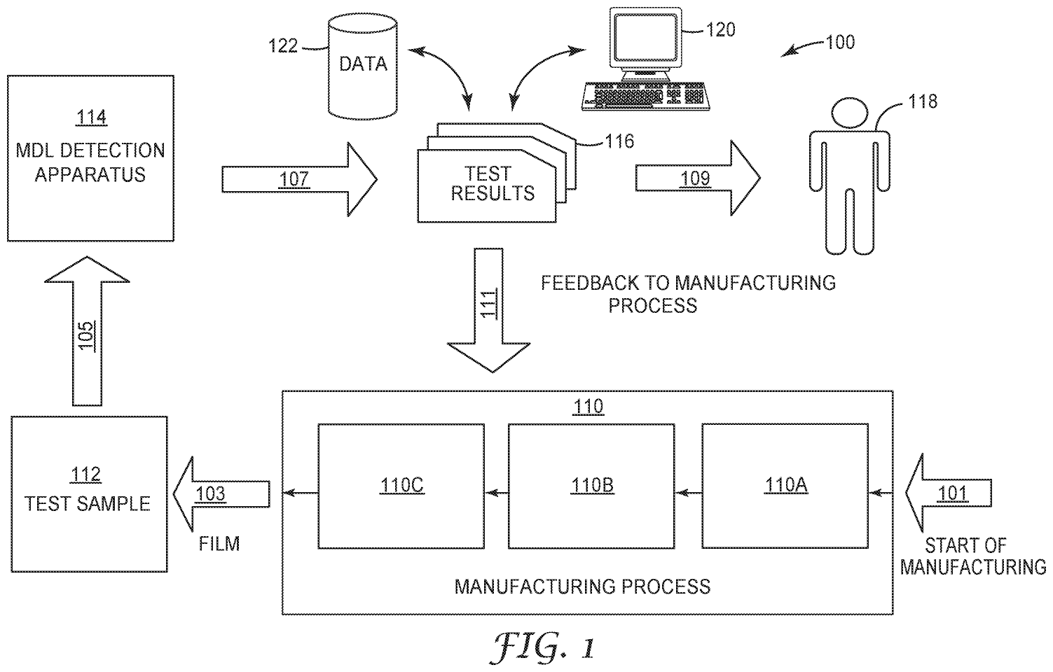

FIG. 1 is a block diagram illustrating an overview of a system 100 for manufacturing a film product, and testing the manufactured film product for MDL defects. Initially, manufacturing process 110 receives various inputs (e.g., material, energy, people, machinery, etc.) 101 and applies manufacturing processes 110A, 110B, and 110C so as to produce film 103. Manufacturing process 110 is not limited to any particular type or form of manufacturing, and is illustrative of any type of manufacturing process operable to produce a film product that can include MDL defects, and that can be tested using any of the example implementations and techniques described herein for MDL defects.

In various examples, output film 103 consists of a film having a nominal thickness and a predetermined width dimension. The film can have a predetermined length, in most instances that can be many times longer than the width dimension, or can be provided from manufacturing process 110 in a continuous length, in either case which can be referred to as a web. In various examples, the film product comprises a single layer of transparent or semitransparent material, although other types of materials provided as output film 103 are contemplated as film products.

According to the techniques described herein, before and/or after conversion to products, test sample 112 is taken from the film 103 produced by manufacturing process 110. In various examples, the test sample 112 is a strip of the film cut cross-web wise across a width dimension of the film to form a rectangle having a length dimension substantially the same as the width dimension of the film, and having a width dimension that is less than the length dimension of the cut sample. In some examples, the width dimension of the test sample 112 is in a range of about one to about six inches. However, the width of test sample 112 is not limited to this dimensional range of widths, and in various examples, can be narrower or wider than defined by this one to six-inch range.

As described herein, test sample 112 is prepared and imaged using MDL detection apparatus 114 according to the various example implementations and techniques described herein. In various example implementations, MDL detection apparatus 114 includes use of a modified Schlieren imaging approach, as is further described herein, to detect fine changes (e.g., nanometer changes) of thickness of the film in a crossweb direction with respect to manufacturing process 110. In various examples, MDL detection apparatus 114 performs various image processing techniques of the image data captured from test sample 112. Image processing associated with MDL detection apparatus 114 is not limited to any particular type or technique of image processing. In various example implementations further described herein, image processing includes summing a quantity of a signal associated with a light intensity value received from imaging across each of a plurality of imaging lines (rows) designated across a width dimension of the test sample 112. In various examples, the imaging lines are lines that run across the test sample 112 in a direction that is perpendicular to a direction of the longitudinal axis of the output film 103 from which test sample 112 was taken, and are thus also perpendicular to a direction the film product was conveyed in during manufacturing process 110.

MDL detection apparatus 114, and in various examples the image data capture and processing performed by MDL detection apparatus 114, provides output 107 including, for example, test results 116 representative of any MDLs introduced by manufacturing processes 110A-C. Test results 116 are not limited to any particular form or type of test results. In various examples, test results 116 include a graphical image resulting from the MDL detection apparatus 114 process, the graphical image comprising an image, or stored data representative of the captured image, that can be displayed and viewed, for example on a computer monitor of computer 120, by an operator 118. In various examples, test results 116 include graphical representations of the image information included in the captured image of test sample 112. Graphical representations of the image captured from test sample 112 are not limited to any particular type of graphical representations. In various examples, graphical representations include graphs having two-dimensional X-Y axis depicting variations in a signal over the surface of test sample 112, the signal indicative of a quantity of light received from each of the imaged rows of test sample 112 during the imaging of the test sample. In various examples, test results 116 include information based on statistical analysis of the data associated with the captured image of test sample 112, either in tabular format, or in a graphical format such as a graph illustrating a bell curve or other statistical distributions of the captured image data. In various examples, other information associated with test sample 112 can be included in test results 116. For example, information related to which shift output film 103 was made during, a date and/or time associated with the manufacturing of output film 103, what raw materials and/or machines were used in the production of output film 103, and what the environmental conditions were, such as ambient temperature of the area where and when output film 103 was manufactured, are examples of information that can be associated with the test sample 112 taken from the particular output film 103 being tested, and can be included in test results 116. The information included in test results 116 is not limited to any particular type of information, and can include any information or types of information deemed to be relevant to the output film 103 and to test sample 112 taken from a particular output film 103.

In various examples, test results 116 include a pass/fail indication with respect to detection of any MDL defects in test sample 112, and if present, the severity and frequency of any such detected defects. In various examples, the pass/fail indication is based on one or more parameters, thresholds, or rules that can be pre-set for determining the pass/fail status of output film 103 in view of the test results 116 associated with test sample 112. In various examples, operator 118 is a technician, engineer, or other person who can inspect test results 116, and make a further determination regarding the status of output film 103 based on results of imaging test sample 112. For example, operator 118 may render a pass/fail determination with respect to any MDL defects detected in test sample 112 relative to whether output film 103 is of a quality level to allow further processing and shipment to customers. In various examples, test results 116 are also operable to provide information 111 that can be used as feedback to manufacturing process 110 with respect to detecting MDL defects. For example, based on information 111 derived from test results 116, adjustments and/or repairs can be made to manufacturing process 110 in order to reduce or eliminate a level of MDL defects that might be generated as part of the manufacturing process 110, thus reducing potential defects and improving the quality of output product 103 in batches of film products manufactured after output film 103 from which test sample 112 was taken was made. The processes illustrated for system 100 can be repeated at some regular interval, or at an interval determined for example based on test results 116. In some examples, a test sample 112 may be taken one or more times from a given batch being provide as output film 103 from manufacturing process 110. In various examples, the interval used to determine when test sample 112 will be taken from output film 103 is determined by a frequency, severity, or both a frequency and the severity of MDL defects being detected in one or more test samples 112. In various examples, a test sample 112 will be taken and imaged when repairs and/or adjustments are made to manufacturing process 110, and as the first output is then being provided as film 103 from manufacturing process 110 following any such repairs or adjustments. In various examples, a test sample 112 will be taken and imaged when a new material is provided at start of manufacturing 101, and the first batch of film 103 is provided from manufacturing process 110 comprising the new material, the captured image information used to evaluate the new material and the film product produced using the new material for the presence, frequency, and severity of any detectable MDL defects.

System 100 includes one or more devices operable to store any of the information described above, including test results 116, as data 122 stored in a database, or in any other type of system or device operable to store test results and any other associated information in a retrievable format. In various examples, data 122 is an electronic database, located either on-site where manufacturing process 110 is taking place, or may be a remote databased coupled to test results 116 via a network, such as the internet or through a local network. In various examples, data 122 represents printed materials stored in a location, such as a file room.

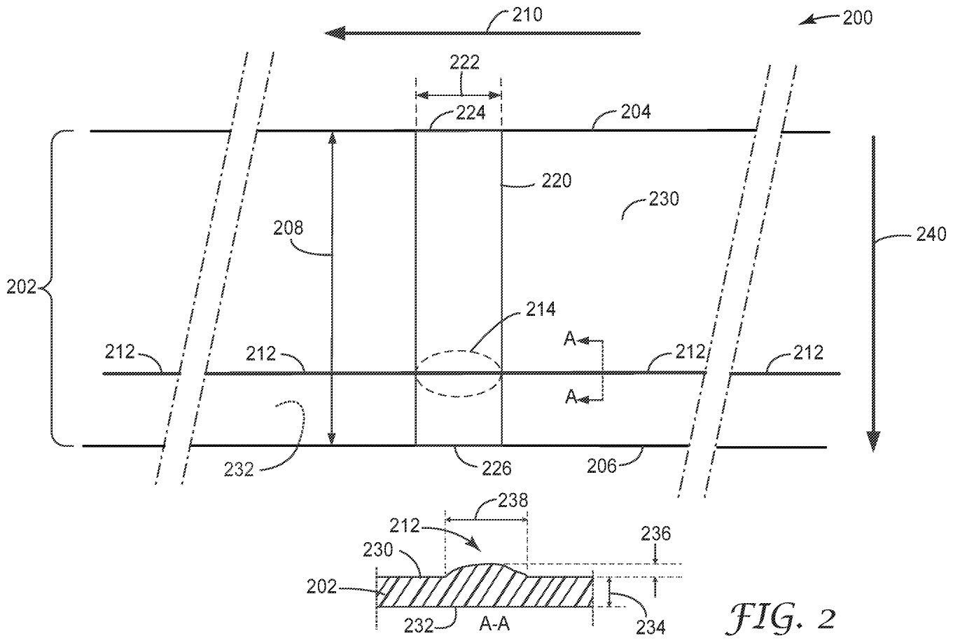

FIG. 2 is a diagram illustrative of a top view of an example portion 200 of a film 202 produced by a manufacturing process (such as film 103 produced by manufacturing process 110) from which a crossweb test sample 220 is extracted. As illustrated, film 202 is provided as a web having a first edge 204, a second edge 206 substantially parallel to first edge 204, and a width dimensions 208 between first edge 204 and second edge 206. In various examples, the value for width dimension 208 is substantially equal along an entire length dimension of film 202. The length dimension of film 202 in some examples is an indeterminate length that is many times longer than the value for width dimension 208. Film 202 includes a planar top surface 230, and a planar bottom surface 232 that is substantially parallel to top surface 230.

In general, web 202 is conveyed within a manufacturing process in a direction indicated by arrow 210, which is along the longitudinal axis of film 202 and referred to herein as a “downweb” direction relative to the original manufacturing process in which the film was produced. In general, film 202 includes one or more MDL defects, generally illustrated by MDL 212, extending along all or portions of the film in the downweb direction. The line shown in FIG. 2 illustrative of MDL 212 is not drawn to scale and, moreover, is illustrative that one or more MDL defects that may be present in film 202. In general, MDL 212 is a defect having a linear direction parallel to the direction of arrow 210 the film 202 is transported along as film 202 is manufactured or otherwise conveyed in during the manufacturing process. MDL 212 is not limited to a single MDL defect, and is not limited to being an MDL defect in any particular position relative to the width dimension of film 202 as shown in FIG. 2. MDL defects can occur anywhere across web 202 relative to the width dimension 208, and can occur with various levels of frequency and/or severity across the width dimension 208 of film 202.

As shown in FIG. 2, a test sample 220 of film 202 is extracted from film 202. Test sample 220 can be extracted or otherwise designated to be along any portion of the longitudinal axis of film 202, and in various examples, is designated to be at or near the end of a length of a film 202 designated to be a batch, a roll, or some other quantification of an amount of film 202, so as to easily be cut from film 202 if desired. As shown in FIG. 2, test sample 220 has a width dimension 222 parallel to the longitudinal axis of film 202, and a length dimension the is substantially equal to the width dimension 208 of film 202. As illustrated, because test sample 220 spans an entire width of film 202, any MDL defects, such as illustrative MDL 212, should cross through the test sample 220, as illustrated by the area designed in dashed ellipse 214.

In various examples, test sample 220 is cut or otherwise separated from film 202 to form test sample 220 having a width dimension 222, and a length dimension equal to width dimension 208. Alternatively, the portion of film 202 represented by test sample 220 need not necessarily be extracted but may be imaged in place by an MDL detection apparatus described herein. In any case, width dimension 222 can be in a range of from about one to about six inches, although width dimension 222 is not limited to this particular range of widths. In various examples, a length dimension of test sample 220, based on width dimension 208, is in a range of about twelve to about one hundred inches, depending on the film product being manufactured, but is not limited to this range for a length dimension, and is various examples is wider or narrower than this length range. Cutting or removal of test sample 220 from film 202 creates a first edge 224 of test sample 220, and a second edge 226 of test sample 220 that is substantially parallel to first edge 224.

Once test sample 220 has been removed from film 202, an MDL detection apparatus imaging described herein (e.g., MDL detection apparatus 114) commences processing test sample 220 to inspect for and detect MDL defects. In general, this includes imaging test sample 220 in a direction 240 that is perpendicular to the original crossweb direction of arrow 210 of the original manufacturing process, e.g., starting at first edge 224, and imaging test sample 220 using imaging rows arranged parallel to one and other in an order starting at or near first edge 224, and working towards second edge 226 in a direction indicted by arrow 240. In doing so, the imaging of test sample 220 occurs, row by row, in a direction that is perpendicular to the direction of manufacturing (indicated by direction arrow 210) of film 202 and may be accomplished by transporting the test sample or by transporting the imaging components of MDL detection apparatus 114. If the film is transported, it may be transported by moving the strip of material past the stationary camera or may be formed into a loop such that the two ends are joined and the subsequent loop rotated past the stationary camera.

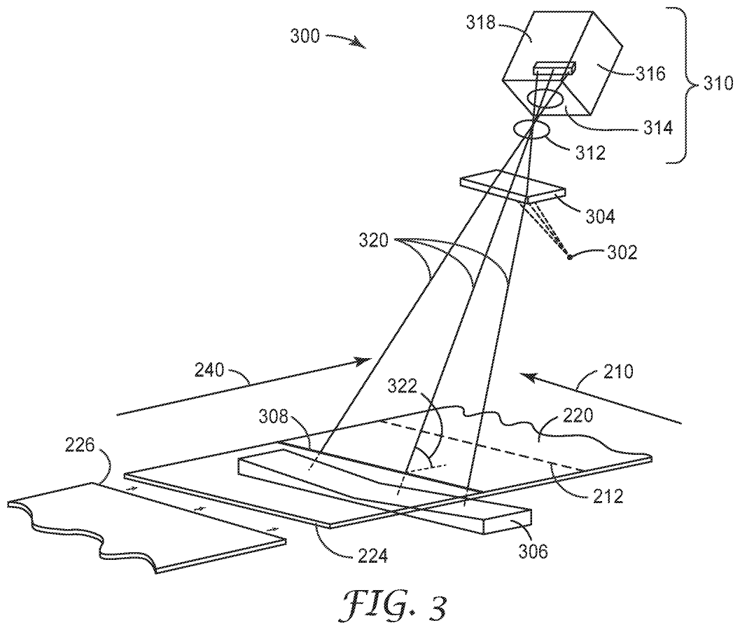

By image scanning the test sample 220 in a direction perpendicular to the downweb direction of arrow 210 of manufacturing of film 202, and using the exemplary implementations and techniques described herein, detection of MDL defects having distortion dimensions in the sub-micron range can be achieved. Section line A-A in FIG. 2 is illustrative of a MDL defect that can occur in a top surface 230 of film 202. As shown in sectional view A-A, MDL 212 represents a surface defect relative to top surface 230 of film 202 having a height 236 above top surface 230, and having and a width dimension 238. Using the exemplary implementations and techniques disclosed herein, MDL defects having a height dimension 236 down to about 100 nanometers can be detected in test sample 220. Using the exemplary implementations and techniques disclosed herein, MDL defects having a width dimension as small as about 10 micrometers can be detected in test sample 220. MDL 212 as shown in sectional view A-A is intended to be illustrative, and MDL defects that can be detected using the exemplary implementations and techniques disclosed herein can have different dimensions, and/or shapes other than that shown for illustrative MDL 212. In various examples, MDL 212 is a defect that provides a void or trough that has a width dimension 238 and/or a dimension of at least the height 236, but wherein dimension 236 is a distance below top surface 230 instead of above surface 230. In various examples, MDL 212 is not limited to being a defect located at or near top surface 230, and can also be detected as a MDL defect located on or near bottom surface 232. Further example illustrations of the use of a test sample, such as test sample 220, to detect MDL defects is provided in FIGS. 3-8 and in the description associated with these figures as described below.

FIG. 3 is a diagram providing a perspective view of one example implementation of an MDL detection apparatus 300 (such as MDL detection apparatus 114 of FIG. 1) for imaging a test sample in accordance with one or more example implementations and techniques described in this disclosure. In general, the MDL detection apparatus 300 is suitable for imaging optical properties of a transparent or semi-transparent film, such as test sample 220 as described with respect to FIG. 2 and as now illustrated in FIG. 3, although imaging of other types of film products is contemplated for imaging using MDL detection apparatus 300. As illustrated in FIG. 3, MDL detection apparatus 300 includes an image capturing device 310 positioned above and at a non-perpendicular line-of-sight angle 322 relative to a top surface of test sample 220. In various examples, line-of-sight angle 322 is 70 degrees, although example implementations of MDL detection apparatus 300 are not limited to any particular non-perpendicular angle value for line-of-sight angle 322. In various examples, image capturing device 310 is operable to perform imaging of test sample 220 to detect MDL defects, if any, present in test sample 220. As illustrated, image capturing device 310 comprises a camera 316 including a lens 312, an aperture 314, and an image sensing array 318. Camera 316 is not limited to any particular type of camera, and in various examples is a line scan camera. In various examples, camera 316 is a Charge-Coupled Device (“CCD”) camera.

As illustrated, MDL detection apparatus 300 includes a point light source 302 that directs light onto beam splitter 304. The light is redirected by beam splitter 304 in a direction that causes the light to be transmitted through the film product of test sample 220 and onto a converging mirror 306. The beam splitter 304 is arranged so that an angle of the light incident to the film product of test sample 220 is a non-perpendicular angle of incidence, in various examples an angle of 70 degrees relative to a top surface of the film provided as test sample 220. After passing through the film product of test sample 220 a first time, in general the light is then reflected back through the test sample 220 through the same line or area used by the light in the first passage of the light through test sample 220. This line or area is referred to as the image area 308. The light reflected from the converging mirror 306 and passing through the image area 308 for the second time is directed to the lens 312. The light from the converging mirror 306 is directed to a point on the lens 312 at a position substantially near the optical center of lens 312. The light passing through lens 312 then continues toward aperture 314 of image capturing device 316. In various examples, the edge of the aperture 314 is set to be at the focal point of the lens 312 between lens 312 and the image sensing array 318.

Depending on the amount of refraction that occurred when the light passed through the film product of test sample 220, in some instances some amount of the light will miss an opening adjacent to an edge of aperture 314, and be blocked by edge of the aperture, and some amount of the light returned can pass through the opening in aperture 314 relative to the edge, and will be received at an image sensing array 318, located in camera 316. In some instances, depending on the amount of refraction that occurred when the light passed through the film product, substantially all of the light returned to the lens will pass through the opening in the aperture. In various examples, the positioning of the aperture is such that the edge of the opening of the aperture will block a portion of the light received back, and allow a remaining portion of the light received back from the test sample to pass through the opening of the aperture when the amount of refractions present in light returned to the lens 312 is returned at an expected angle of refraction. For example, when the refraction of the light returned to lens 312 is at the same 70 degrees of refraction as was used in providing the light from the light source and the beam splitter to the test sample. The level of light received and not received by the image sensing array 318 is captured and forms electrical signals corresponding to the image area 308 of test sample 220. In the instance described above wherein the light is received back at lens 312 based on the expected angle of refraction, the amount of light the passed through the opening of aperture 314 and is provided to image sensing array 318 generates an electrical signal corresponding to a level of light intensity in a range of light intensity that can be referred to as the expected level of light intensity.

In other instances, the light that is refracted in passing through the film product of test sample 220 will be refracted enough that the light rays, when incident upon the aperture, will miss the opening of the aperture, being substantially entirely blocked by the aperture 314, and will not be received at image sensing array 318. In this instance, the amount of light provided to image sensing array 318 that generates an electrical signal corresponding to a level of light intensity in a range of light intensity is less than the expected level of light intensity described above compared to the level of light was returned to the lens 312 at the expected angle of refraction. In still other instances, the light that is refracted in passing through the film product of test sample 220 will be refracted enough that the light rays, when incident upon the aperture, completely or substantially avoid being blocked by the edge of aperture 314. In such instances, a level of light intensity that will be provided at image sensing array 318 is larger than the level of light intensity that is provided at the expected light intensity level. In this instance, the amount of light provided to image sensing array 318 that generates an electrical signal corresponding to a level of light intensity in a range of light intensities is greater than the expected level of light intensity described above in the instance were the light was returned to the lens 312 at the expected angle of refraction.

The level of light received and not received by the image sensing array 318 is captured and forms electrical signals corresponding to the image area 308 of test sample 220. As further described below, there variations in the level of light intensity received and converted to electrical signals by image sensing array 318 can be processed to detect MDL defects in test sample 220, and to determine the severity and frequency of any MDL defects detected in test sample 220. In various example implementations, test sample 220 is conveyed in a direction relative to the position of image area 308 so that the area imaged by image capturing device 310 moves along test sample 220 in a direction indicated by arrow 240. As test sample 220 is moved, the image captured for a given image area 308 is associated with the captured image for the area of test sample 220 imaged by image area 308. As test sample 220 is moved, each new area of test sample 220 is associated with a new image area 308 and a new image is captured by imaging the new area of test sample 220 that is presented at image area 308 at the time the imaging for that area occurred. In this manner, the electrical signals from the image sensing array 318 represent a series of the images of test sample 220, taken image area by image area, along a length of test sample 220, and may then be processed and analyzed using image processing techniques for the purpose of detecting MDL defects in test sample 220.

In various examples, beam splitter 304 is utilized to divide a light beam into two or more paths. Beam splitter 304 may be employed in various alignments to provide coaxial lighting. Coaxial lighting may assist in reducing the occurrence of single features represented twice on a single image, also referred to as ghosting. In various example implementations, conventional beam splitters are suitable for use with MDL detection apparatus 300. In various examples, the converging mirror 306 is configured specifically such that light emitted from the point light source 302 and redirected by beam splitter 304 is directed back to a point after reflecting from the mirror surface. The converging mirror 306 directs light to a point at a position near the optical center of lens 312. In various examples, converging mirror 306 may be converging in at least one dimension and preferably two dimensions. The type of converging mirror employed affects the imaging system's sensitivity. Certain forms of transparent media and specific types of optical properties require higher quality mirrors in order to appropriately image specific optical properties. Those skilled in the art are capable of matching mirror quality to achieve the level of imaging needed for specific transparent films. Example implementations and techniques may also employ flat mirrors to fold the optical path of the light rays, thereby drastically reducing physical space requirements for the inventive apparatus. Lens 312 is employed to bend light rays, causing them to converge and create an image directed to aperture 314 and image sensing array 318. In various examples, the lens serves to map a physical section of the test sample 220, illustrated as image area 308, to a corresponding position on the image sensing array 318. The lens 312 is preferably focused on a line, illustratively represented by image area 308, which corresponds to the position of the film product of test sample 220 at image area 308.

In various examples, the image sensing array 318 is an array of photosensitive devices capable of converting incoming light photons into electrical signals. The lens 312 forms an image on the image sensing array 318. The image sensing array 318 converts image intensity to corresponding electrical signal amplitudes. The signal created by the image sensing array 318 is a captured (electronic) image representative of the optical image transmitted to image sensing array 318 by the lens 312. In various examples, conventional image sensing arrays generally recognized by those skilled in the art are suitable for use with the example implementations and techniques described herein. In various examples, image sensing array 318 may include either one-dimensional or two-dimensional arrays of a charge coupled device (“CCD”), a complementary metal oxide semiconductor (“CMOS”), or photodiodes.

As described above, in various examples test sample 220 is conveyed so that image area 308 moves over test sample 220 in a direction illustrated by arrow 240, which is a same direction illustrated by corresponding arrow 240 in FIG. 2, representing the image area 308 moving in a direction from first edge 224 of test sample 220 towards second edge 226 of test sample 220. In various examples, second edge 226 is coupled to first edge 224, as shown in FIG. 3, in order to form the film of test sample 220 into a continuous loop, and thereby allowing test sample 220 to be conveyed through MDL detection apparatus 300 one or more times for image capturing. In this manner, the image area 308 moves in a direction that is perpendicular to the direction (the perpendicular direction indicate by arrow 210) of the direction the film product was conveyed in when the film product from which test sample 220 was taken was being manufactured or otherwise conveyed.

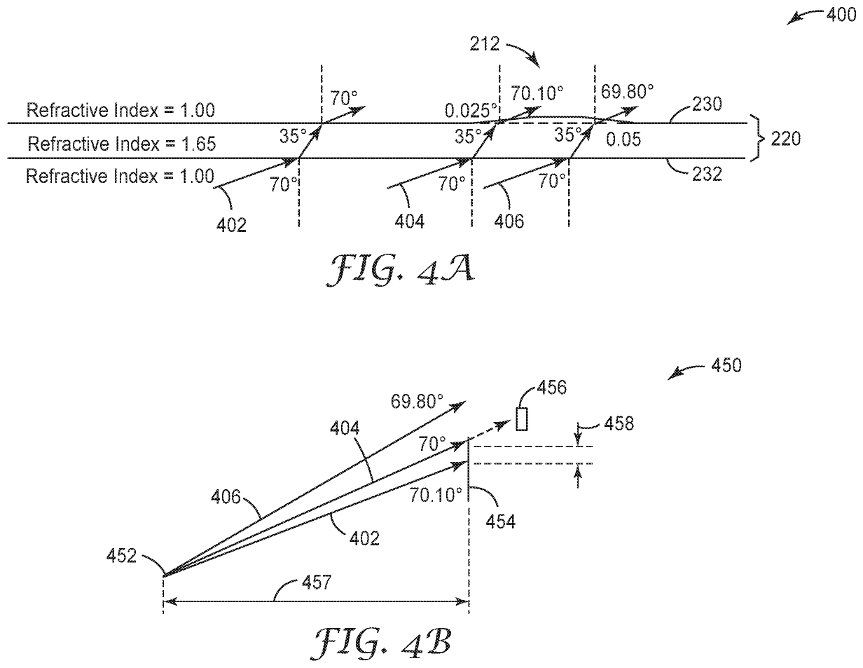

As image area 308 moves along test sample 220 in the direction of arrow 240, the image area 308 will eventually come into the area of test sample 220 that includes MDL 212. In some instances, when the light rays represented by 320 are refracted by the MDL 212 defect, the angle of entry back through beam splitter 304 and lens 312 will be altered to an extent that some portion or substantially all of these light rays will be directed through lens 312 and will be blocked by the edge of aperture 314 rather than passing through the aperture opening. The light rays blocked by the edge of the aperture thus will not reach the imaging sensing array 318, and will result in image sensing array 318 capturing less light relative to the image area 308 when MDL detection apparatus 300 is imaging test sample 220 in the area of MDL 212. In other instances, when the light rays represented by 320 are refracted by the MDL 212 defect, the angle of entry back through the film product the second time will be different from the path these light rays took on the first pass through the film product, and will be reflected back to lens 312 in a direction that will cause more of these light rays to pass through the opening of aperture 314 and be provided to image sensing array 318. The difference in the direction of these light rays as provided to lens 312, having more of these light rays directed to the opening in aperture 314, will cause a greater level of light intensify to be directed to a portion of image sensing array 318 that mapped to the corresponding portion of test sample 220 that is being imaged as image area 308 at that time, and thus will generate a brighter image relative to that portion of test sample 220 that is different from what would be expected if the light rays had not be refracted by the MDL 212 defect. Whether the refraction of the light rays while imaging test sample 220 in the area of the MDL 212 defect result in the light rays being blocked by aperture 314, or the refraction of the light rays while imaging test sample 220 in the area of the MDL 212 defect result in less of the light rays being blocked by aperture 314 depends on the contour of the MDL defect that is being imaged at the time as image area 308, as is further illustrated and described below with respect to FIGS. 4A and 4B. By directing light to test sample 220 at a line-of-sight angle 322, and using mirror 306, lens 312, aperture 314, and image sensing array 318 as shown in FIG. 3 to exploit the variations in the angle of refractions created by any MDL defects in test sample 220, MDL detection apparatus 300 is operable to capture image information related to test sample 220 that can be processed and used in the detection and quantification of MDL defects present in test sample 220.

In various examples, image capturing device 316 includes one or more devices operable to perform the imaging as described above, and further includes one or more devices operable to provide some or all of image processing of the captured images provide by imaging the test samples. In various examples, imaging is performed by one or more of the example image capturing devices described herein. In various examples, the image capturing device can provide some or all of the image processing of the images captured by imaging the test samples. In various examples, some or all of the image processing is performed by devices other than the image capturing device, such as but not limited to computer 120 shown in FIG. 1. In various examples, image capturing device 316 is communicatively coupled to one or more other devices, such as but not limited to computer 120, and is operable to provide communications both to and from these one or more other devices in order to transfer information back and forth related to captured images, processed image information, and/or parameters related to the imaging capturing process itself. As described herein, MDL detection apparatus 300 provides a modified Schlieren imaging system that allows imaging and recording, with a high degree of sensitivity, very subtle variations in the optical caliber properties of a film product.

FIG. 4A is a diagram providing a cross-web view 400 (i.e., side view in the crossweb direction) of test sample 220 illustrating refraction of light rays passing through test sample 220 when processed by an MDL detection apparatus according to examples described in this disclosure. As shown in FIG. 4A, test sample 220 has a nominal thickness dimension defined by top surface 230 and bottom surface 232. Test sample 220 also illustrates the example MDL 212 defect on top surface 230.

In this example, the ambient area above top surface 230 has a refraction index of 1.00 for light rays passing through that area, and the ambient area below bottom surface 232 has a refraction index of 1.00 for light rays passing through that area. As illustrated in the example of FIG. 4A, the film product of test sample 220 has a refraction index of 1.65 through the dimensional thickness of test sample 220 between top surface 230 and bottom surface 232. An illustrative light ray 402 is provided in FIG. 4A, passing through a portion of test sample 220 that does not include the area where MDL 212 is located. Light ray 402 is incident to bottom surface 232 at an angle of 70 degrees relative to an axis perpendicular to bottom surface 232. Due to the differences in the refraction indexes for the ambient area below bottom surface 232 and the test sample 220, light ray 402 is refracted to an angle of 35 degrees relative to the axis perpendicular to bottom surface 232 when passing through the film product of test sample 220. As light ray 402 exits from the film product of test sample 220 and into the ambient area above top surface 230, light ray 402 again assumes an angle of 70 degrees relative to an axis perpendicular to top surface 230, which is a same angle of incidence used to provide light ray 402 to bottom surface 232. In various examples, the angle of refraction provided when light ray 402 exits top surface 230 is referred to as the expected angle of refraction.

Another illustrative ray of light, light ray 404, is illustrated in FIG. 4A as being incident on bottom surface 232 at a same 70-degree angle as was described above for light ray 402. Upon entering the film product of test sample 220, light ray 404 is refracted to an angle of 35 degrees relative to an axis perpendicular to bottom surface 232. However, due to the difference in the couture of top surface 230 in the area where light ray 404 is exiting out of the film product to the ambient area above top surface 230 no longer being co-planer with bottom surface 232, light ray 404 exits the film product of test sample 220 at an angle of 70.10 degrees instead of the 70 degrees exit angle of light ray 402. This difference between the 70-degree angle (expected angle of refraction) for light ray 402 and the 70.10-degree angle of exit for light ray 404, when projected over a distance, can result in a different in a position that these light rays arrive at relative to a lens and an aperture of an imaging system, such as the lens 312 and the aperture 314 described above with respect to MDL detection apparatus 300 of FIG. 3, and as further illustrated and described below with respect to FIG. 4B.

Referring again to FIG. 4A, in another example, an illustrative light ray 406 is provided to bottom surface 232 of test sample 220 in an area of MDL 212, but in an area different from the area where light ray 404 was provided to bottom surface 232. In a manner similar to that described above for light ray 404, light ray 406 is provided to bottom surface 232 at an angle of 70 degrees relative to an axis that is perpendicular to bottom surface 232. As light ray 406 enters the film product of test sample 220, light ray 406 is also refracted to an angle of 35 degrees relative of an axis perpendicular to bottom surface 232. Again, due to the difference in the couture of top surface 230 in the area where light ray 406 is exiting the film product of test sample 220 to the ambient area above top surface 230 caused by MDL 212, light ray 406 is refracted to an angle of 69.80 degrees relate to an axis perpendicular to top surface 230. Thus, light ray 406 is not provided from the film product of test sample 220 at the expected angle of refraction of 70 degrees, and in addition, is provided at an angle (i.e., 69.80 degrees) that is different from the angle (i.e., 70.10 degrees) provided by light ray 404. Thus, as illustrated in FIG. 4A, by providing light incident to a first surface of a test product at a fixed angle, disturbances in a surface caused by MDL defects provide differences in the angles of refraction of the light rays provided as corresponding light rays provided as outputs at the second surface of the film product. These differences in angles of refraction are exploited, as further described herein, so that when imaging these light rays provided as an output light rays exiting the film product, MDL defects can be detected and identified with respect to the severity and/or with respect to frequency of MDL defects within test sample 220.

FIG. 4B is a diagram 450 of test sample 220 illustrating refraction of light rays while processed by an MDL detection apparatus according to the example implementations and techniques described in this disclosure. As illustrated, light rays 402, 404, and 406 (as described above) are provided from a point source 452. In various examples, point source 452 of the MDL detection apparatus is a lens, such as lens 312 of image capturing system 300, directing light rays 402, 404, and 406 after the light rays have passed through the film product of a test sample, such as test sample 220 as illustrated in FIG. 4A. As shown in FIG. 4B, each of light rays 402, 404, and 406 are directed from point source 452 toward an aperture 454 located between point source 452 and an image sensing array 456. In various examples, aperture 454 is set to be at the focal point behind lens 452, having the edge of the opening in aperture 454 set so that when light rays are received at lens 452 at the expected angle of refraction as described above, a portion of the light rays directed from lens 452 will be blocked by aperture 454, and the remaining portion of the light rays received at lens 452 will not be blocked by the edge of aperture 454, and will pass through the opening in aperture 454 to be provided to image sensing array 456. In various examples, the portion of light rays that are not blocked by aperture 454 and that provide a level of light intensity to image sensing array 456 is referred to as the expected level of light intensity.

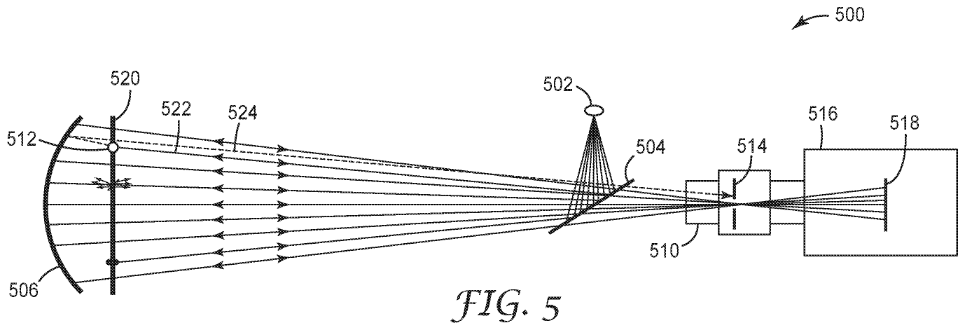

Thus, aperture 454 includes an opening that is adjusted relative to the position of point source 452 so that some portion of light rays provided by point source 452 at an angle of 70 degrees (expected angle of refraction) will pass through the opening of aperture 454 and be provided to image sensing array 456 at a position of image sensing array 456 that is mapped to an area of test sample 220 being imaged at the time the light rays were provided to test sample 220. As illustrated, light ray 404 was refracted at an angle of 70 degrees when exiting test sample 220, and is provided from point source 452 at an angle representative of the 70 degree exit angle. As such, some portion of light ray 404 will be blocked by aperture 454, while the remaining portion of light ray 404 will pass through the opening in aperture 454, and is provide to image sensing array 456 at a portion of image sensing array 456 that is mapped to a portion of test sample 220 that is being imaged at the time light ray 404 was provided to test sample 220. In contrast, illustrative light ray 402 is provided from point source 452 at an angle representative of a light ray exiting test sample 220 at an angle of 70.10 degrees. Over the distance 457 provided between point source 452 and aperture 454, the refraction of light ray 402 at an exit angle of 70.10 degrees causes light ray 402 to strike aperture 454 at a dimension 458 that is below the opening in aperture 454. As such, the light comprising light ray 402 is not provided to image sensing array 456, resulting in image sensing array 456 capturing no light, or a quantity of light that is less than the amount of light that would be expected at the image sensing array 456 had light ray 402 been refracted at 70 degrees instead of 70.10 degrees. As a result of light ray 402 being blocked by aperture 454, the area of image sensing array 456 mapped to the portion of test sample 220 being imaged when light ray 402 was provided to test sample 220 will capture a lower level of light intensity for that portion of the image. Using image processing techniques, this different in the intensity of the light captured by image sensing array 456 for the portion of test sample 220 that refracted light ray 402 at 70.10 degrees can be used for detection and quantification of MDL defects in test sample 220 as further described below with respect to FIG. 5.

Referring again to FIG. 4B, illustrative light ray 406 is provided from point source 452 at an angle representative of a light ray refracted at an angle of 69.80 degrees when light ray 406 was exiting test sample 220. Over the distance 457 provided between point source 452 and aperture 454, the refraction of light ray 406 at an exit angle of 69.80 degrees causes a larger portion of light ray 406, or in some instances substantial all of light ray 406, to pass through the opening of aperture 454, and is directed to a portion of image sensing array 456 that is mapped to the portion of test sample 220 being imaged at the time light ray 406 was provided to test sample 220. As a result of light ray 406 being substantially passed through the opening in aperture 454, the area of image sensing array 456 mapped to the portion of test sample 220 being imaged when light ray 406 was provided to test sample 220 will capture a higher level of light intensity for that portion of the image. Using image processing techniques, this different in the level of the light intensity captured by image sensing array 456 for the portion of test sample 220 that reflected light ray 406 at 69.80 degrees can be used for detection and quantification of MDL defects in test sample 220 as further described below with respect to FIG. 5.

FIG. 5 is a block diagram of a side-view of an example MDL detection apparatus 500 operable to provide imaging of a test sample 520 according to example implementations and techniques described in this disclosure. MDL detection apparatus 500 represents an example implementation of MDL detection apparatus 114 of FIG. 1, for example.

As illustrated, MDL detection apparatus 500 includes an image capturing device 516 comprising a lens 510, an aperture 514, and an image sensing array 518. In various examples, image capturing device 516 is the image capturing device 310 illustrated in FIG. 3 and described above, although examples of image capturing device 516 are not limited to image capturing device 310. As illustrated in FIG. 5, MDL detection apparatus 500 includes a light source 502 providing a source of light to beam splitter 504. Beam splitter 504 provides light rays that are projected out from beam splitter 504 to test sample 520, comprising a test sample taken from a film product as described herein. Light rays provided to test sample 520 from beam splitter 504 are provided at a non-perpendicular angle of incidence relative to the surface of test sample 520, in some examples at an angle of incidence of 70 degrees relative to a surface of the film product.

As illustrated in FIG. 5, light rays passing through test sample 520 may be obscured by an object in the film product, scattered by an object in the film product, or refracted by one or more MDL defects occurring in the test sample 520. For light rays not obstructed, scattered, and not refracted due to an MDL defect, after passing through the film product 520 for the first time, the light rays are reflected back from mirror 506 in manner so as to pass back through test sample 520 a second time, reflected by mirror 506 back toward the lens 510 of image capturing device 516 along a same path that the light rays were provided to the test sample 520 by beam splitter 504, and will be directed to the lens 510, wherein lens 510 is operable to focus the light rays to a focal point located behind lens 510 at aperture 514. Aperture 514 includes an opening and an edge of the opening. The edge of the opening is positioned so that when light ray reflected back to lens 510 are received at the expected angle of refraction, a portion of the light rays will be blocked, and a portion of the light rays will pass through the opening in aperture 514, and are provided to image sensing array 518. In addition, these light rays will be provided to a portion of the image sensing array 518 that is mapped to a portion of the test sample 520 that is being imaged at the time these light rays were provided to the test sample 520. Under these conditions, the level of the light intensity received and imaged by the image sensory array 518 for the imaged portion of test sample 520 would fall within an expected level of light intensity for light rays that are not obscured, scattered, and that are not refracted by an MDL defect in the test sample 520.

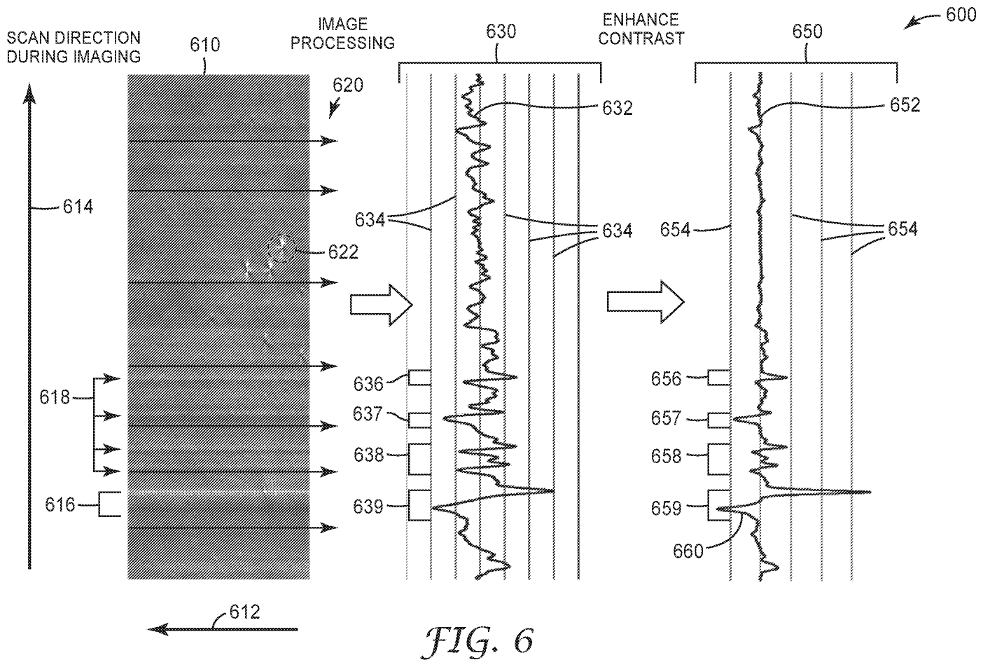

Light rays that are obstructed when provided to test sample 520 do not reach mirror 506, and thus are not reflected back to imaging sensing array 518. In general, these obstructions are only one spot or a small area in the film product 520, and do not extend across an entire width of the test sample 220, and thus result in a darker image representative of a spot defect in the image captured from test product 220 while imaging the area of the test sample 520 that contains the obstruction. In a similar matter, a defect in test product 520 causing light rays to be scattered in various examples may not be reflected by mirror 506 to image sensory array 518, and can create images appearing as darker spots or darker areas related to an image of test sample 520 in the area of the defect. Again, these types of defects are, in general, only one spot in the film product, and do not extend across an entire width of the test sample 220, and thus result in a spot defect in the image captured from test product 220 in the area of test sample the includes the defect that caused the scattering of the light. These types of defects can be discriminated from MDL type defects as further described below with respect to image processing, as illustrated and described with respect to FIG. 6.

For light rays that are provided to test product 520 in an area of the test product that includes an MDL defect, shown in FIG. 5 as illustrative the MDL 512 defect, the light rays in some instances may be refracted on the first pass through test sample 520 at an angle such that the light rays will not pass back through test product 520 along a same path as these same light rays traveled during the first pass through test product 520. As illustrated FIG. 5, light ray 522 is directed from beam splitter 504 to an area of test sample 520 that includes the MDL 512 defect. As light ray 522 passes through test product 520 for the first time, light ray 522 is refracted by MDL 512 so that light ray 522, when reflected by mirror 506, passes through test product 520 along a different path, represented by light ray 524, then was traveled by light ray 522 of its first pass through test product 520. This difference in angles results in light ray 524 being directed to the lens 510 of image capturing device 516 at an angle that causes light ray 524 to miss the opening of aperture 514 and be blocked by the edge of the opening in aperture 514. Aperture 514 thus blocks light ray 524, preventing light ray 524 from reaching image capturing array 518. The blocking of light ray 524 will, as described above with respect to FIG. 4B, result in image capturing array 518 capturing a lower level for the light intensity than the expected light intensity level for the area of test sample 520 corresponding to the area that includes the MDL 512 defect. By detecting this lower imaged level of light intensity, a detection and quantification can be made that the MDL defect is present in test sample 520 at the portion of test sample 520 being imaged when the light ray 522 was provided to the test sample.

In a similar manner as described above with respect to light ray 406 and FIG. 4B, in other instances light rays provided to test sample 520 in the area of test sample 520 that includes the MDL 512 defect can be refracted when passing through the MDL 512 defect in a direction that cause these light rays, when reflected back to image capturing device 516, to have a larger portion, or in some instances substantially all of the light rays received at lens 510, to be directed through the opening of aperture 514. As a result, the refraction of these light rays due to MDL 512 will result in image sensing array 518 capturing a level of light intensity that is higher than the expected light intensity level for the area of test sample 520 corresponding to the area that includes the MDL 512 defect. By detecting these higher imaged levels of light intensity, a detection and quantification can be made that a MDL defect is present in test sample 520 at the portion of test sample 520 being imaged when the light ray 522 was provided to the test sample.

FIG. 6 illustrates an example image 610 and examples of graphical information 630, 650 generated by a MDL detection apparatus from imaging a test sample in accordance with example implementations and techniques described herein. Image 610 is an example image that is generated from imaging a test sample, such as but not limited to test sample 220 shown in FIGS. 2 and 3, or test sample 520 as shown in FIG. 5. Image 610 includes illustrative examples of what may be classified a MDL defects, indicated by brackets 616 and 618. A portion of image 610 associated with bracket 616 appear as a ridge like formation running in a direction of manufacturing, indicated by arrow 612, across the test sample imaged to generate image 610. The portion of image 610 associated with bracket 618 appears to be a series of lines or small ridge-like formation running in a direction of manufacturing, again indicted by arrow 612, across the test sampled that was imaged to generate image 610. Arrow 614 indicates a direction used to image the test sample that was imaged to generated image 610, and as shown is a direction that is perpendicular to arrow 612 and thus perpendicular to the direction of manufacturing of the test sample that was imaged to generate image 610. In addition, a spot defect, such as described above as created for example by an obstruction or by scattering, is illustrated by the area of image 610 enclosed the dashed-lined circle 622, and is further described below.

As shown in FIG. 6, image 610 produced by the MDL detection apparatus provides a visual representation of an image generated by imaging a test sample using the example implementations and techniques described herein. In various examples, an operator, such as operator 118 as shown in FIG. 1, can display image 610 on a device such as a computer monitor (for example the computer monitor associated with computer 120 in FIG. 1), and perform an initial assessment as to the severity and frequency of an MDL defects that appear in image 610. In various examples, visual inspection of image 610 can be adequate to make an initial determination as to whether any detected MDL defects render the film product from which the test sample was taken and imaged to generated image 610 would be unfit for further processing and/or sale to a customer.

In addition, the MDL detection apparatus can perform further image processing of image 610 to provide quantification of image 610 with respect to detection and quantification of image 610 relative to MDL defects. In various examples, a series of rows are defined throughout the image 610, indicated by illustrative arrows 620, wherein the rows are defined at some predetermined interval along image 610 in a direction indicated by arrow 614. Each row parallels the direction of manufacture of the test sample that was imaged to generate image 610, as indicted by arrows 612. The spacing and quantity of arrow 620 is only illustrative, and in various examples the quantity of rows designated across image 610 would include many more rows than are illustrated by arrows 620, in some examples with a predetermined spacing between rows, or in other examples having rows defined with a width such that the entire area of image 610 is included in one of the rows designated by arrows 620.

In various examples, each row corresponds to a single image scan line, such as image area 308 illustrated in FIG. 3, although examples are not limited to having a one-to-one correspondence between the image scan lines used in the imaging of the test sample and the rows defined by illustrative arrows 620 across the test sample. In various examples, an average of the intensity of the light is calculated across each of the rows of image 610, and in various examples, the average of the light intensity across each row is plotted for example as graph 630. As illustrated, graph 630 includes an intensity line 632 showing the variations in light intensity across rows of image 610 relative to threshold lines 634. As shown, the portion of intensity line 632 associated by brackets 636, 637, 638, and 639 are illustrative of possible MDL defects corresponding to the area indicated by bracket 618. Each of these portions of intensity line 632 associated with brackets 636, 637, 638 cross more than one of threshold lines 634 within the length of intensity line 632 defined by each of brackets 636, 637, and 638, respectively. In various examples, instances of intensity line 632 crossing multiple threshold lines within a predetermined length of intensity line 632 can trigger an indication of a detected MDL defect.

In addition, the portion of intensity line 632 associated with bracket 639 is illustrative of a possible MDL defect corresponding to the area of image 610 indicted by bracket 616. As illustrated, the portion of intensity line 632 associated with bracket 639 crosses multiple threshold lines 634, and extends past one or more of these threshold lines beyond a threshold line crossed by the intensity line 632 in any of the portion of intensity line 632 associated with brackets 636, 637, or 638. In various examples, an indication of intensity line 632 crossing a particular one of the threshold lines 634 can trigger an indication of a detected MDL defect. These examples are intended to be illustrative of the type of defects in a film product that can be determined to represent MDL defects based on illustrative intensity line 632. These examples are merely illustrative, and in no way limit the possibility for using information derived from image 610 for detecting and quantifying image 610 with respect to MDL defects.

In various examples, spot defect 662, as illustrated by the area included within dash-lined circle 622, can be filtered out as “noise” because while spot defect 622 is obvious visually when looking at image 610 as displayed, when added together and averaged with the values for the entire row or rows in which spot defect 622 might be included within, the effect of the light intensity represented by spot defect 662 does not have a large impact on the average light value for that entire row or rows. By adding the values across the entirety of each row, and then taking an average value for that row as the “light intensity” value for that row, the effect of spot defects can be filtered out of the light intensity line 632 as illustrated in FIG. 6. However, as noted above, because an MDL defect provides an alteration in the expected level of light intensity across the entirety of a row or rows, variations in the light intense for the row or rows corresponding to the MDL defects will not be filtered out by this summation and averaging, and can be further processed to indicate the presence, severity, and frequency of MDL defects in image.

In various examples, image processing of intensity line 632 includes removal of a DC offset. In various examples, removal of a DC offset comprises setting the level of expected light intensity, as described above, to have relative value of zero, so that light intensity values having a value less than the expected light intensity level have a negative value, and light intensity levels that are higher in value than the expected light intensity level have a positive value. In various examples, removal of a DC offset includes subtracting a value, such as an average value of the light intensity across the intensity line 632, from each of the values represented along the entirety of intensity line 632, generating an intensity line 632 having a center line representative of a light intensity value of zero. In various examples, removal of a DC offset includes performing a low pass filter function of the values of intensity line 632, and then subtract the low pass filtered value for the original values of intensity line 632.

In various examples, intensity line 632 is further processed to increase contrast in order to generated contrast enhanced line 652, as illustrated in graphical information 650. This process weights those areas of intensity line 632 with greater deviation so as to have a higher value represented by contrast enhanced line 652. For example, the area associated with bracket 616 in image 610 and with bracket 639 associated with this corresponding portion of intensity line 632, when contrast is enhanced, generates a portion of contrast enhanced line 652 having a first peak 660 that exceeds a threshold line 654, and having a second peak 661 that exceeds several additional threshold lines 654. In graphical information 650, the portion of contrast enhanced line 652 associated with brackets 656, 657, 658 corresponding to the areas of image 610 associated with area 618 and brackets 636, 637, and 638 intensity line 632 which do not extend past any of threshold lines 654 in graphical information 650. As such, the contrast of the possible MDL defect in the area of image 610 associated with bracket 616 is enhanced by the enhancement processing to further contrast the variations in intensity line 632, and in various examples helps to further quantify the presence, severity, and frequency of any MDL defects that might exist in a test sample that was imaged to generate example image 610. In various examples, the setting of the values for the threshold lines 654, and using these set values to determine the number, extent, durations, and frequency of instances of enhanced contrast line 652 relative to these threshold lines 654 can be used detect the presence, severity, and frequency of MDL defect, and can be used to set pass/fail criteria for test sample imaged as image 610. In various examples, various parameters, such as filter values, DC offset values, the values for threshold lines, and other parameters used for processing image 610 can be provided and modified at inputs, but example by an operator, engineer, or technician, as part of the image processing and pass/fail determination used with respect to image 610 and the test sample that was used in the generations of image 610.

In various examples, one or more forms of data extraction are performed on the graphical information extracted from image 610. The types of data extraction and processes used to extract data are not limited to any particularly types of data or processes, and can include any data and data extraction processes deemed useful in detecting and quantifying the frequency and severity of MDL defects based on the example implementations and techniques describe herein. In various examples, a plurality of arrays is extracted by creating arrays at various spatial resolutions of an image such as image 610. For example, a set of arrays of image 610 can be created using special resolutions for each of 2.5 mm, 5 mm, 10 mm, 20 mm, and 40 mm. For each element in the array, a maximum deviation and a standard deviation can be calculated. Based on these calculations, various values for the spatial arrays can be compared against thresholds or ranges of values to determine an overall pass/fail status of the imaged test sample of film product from which that data was derived.

In various examples, all or any of the information contained in and extracted from image 610, and/or graphical images 630 and 650, can be provided as test results, such as test results 116 shown in FIG. 1, and can be provided in graphical form, in data tabular or spreadsheet format, or any other representation or format for display by the monitor associated with computer 120 as shown in FIG. 1. Various data can be extracted from the image information obtained from image 610, intensity line 632, and/or enhanced contrast line 650. For example, with respect to the overall scan, calculation can be made regarding the total number of peaks, and a roughness parameter Rₐ can be calculated based on various parameters of the image information, including but not limited to a roughness parameter calculated based on an arithmetic average of the absolute values of the data, a maximum peak height, or a maximum valley depth. Data can also be extracted relative to the individual peaks and valleys of the graphical information, including calculating the crossweb position of the individual peak or valley, a height (signed) for the peak or valley, and a distance calculation of space or distance between a peak and a valley, or between two peaks, or between two valleys. Data extraction is not limited to these examples, and can including any image processing and data extraction methods or techniques that are deemed useful for detecting the presence, severity, and/or frequency of MDL defects in test sample images including test sample images generated using any of the example implementations and techniques described herein, and the equivalents thereon.

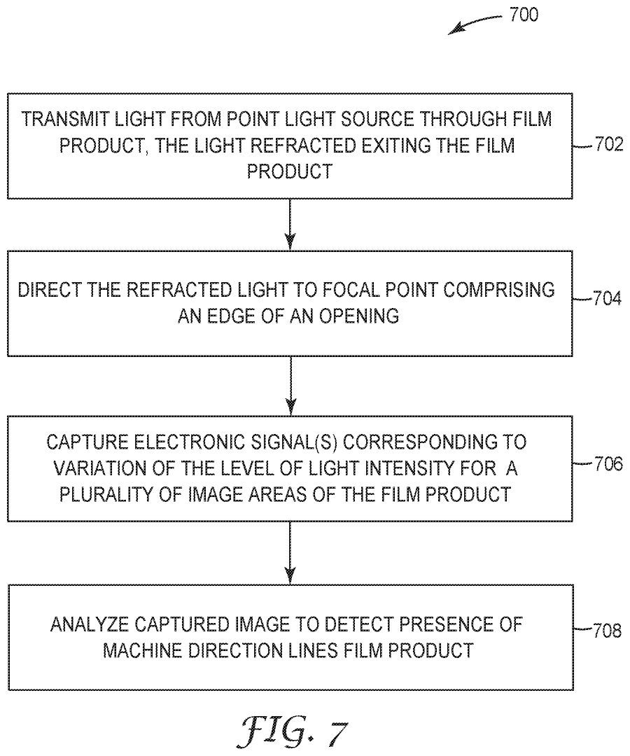

FIG. 7 is a flowchart illustrating one or more example methods 700 performed by an MDL detection apparatus (e.g., MDL detection apparatus 114, 300, 500) in accordance with various techniques described in this disclosure. Although discussed with respect to MDL detection apparatus 300 as illustrated and described with respect to FIG. 3, the example methods 700 are not limited to the example implementations illustrated with respect to MDL detection apparatus 300 and FIG. 3. In various examples, the techniques of example methods 700 can be implemented, in whole or in part, by MDL detection apparatus 114 as shown in FIG. 1, or by MDL detection apparatus 500 as shown in FIG. 5

In various examples, point light source 302 transmits light from the point light source through the film product 220 (block 702), the light refracted at an angle of refraction when passing through and then exiting the film product.

In various examples, the refracted light is directed, using lens 312, to a focal point comprising an edge of an opening of an aperture 314 (block 704), wherein the edge is positioned to block a portion of the refracted light from passing through the opening, while allowing the remaining portion of the refracted light to pass though the opening of the aperture 314 and be received at an image sensing array 318 when the angle of refraction of the light received at the focal point is an expected angle of refraction.

In various examples, positioning the edge to block further comprises positioning the edge to receive the refracted light at the focal point, the refracted light having an angle of refraction that is different from the expected angel of refraction; blocking a portion of the refracted light that is a different amount of the refracted light than would be blocked when receiving the refracted light at the expected angle of refraction; to allow a remaining unblocked portion of the refracted light to pass though the opening of the aperture, and to receive the remaining unblocked portion of the refracted light at an image sensing array. In various examples, the different amount of the refracted light that is blocked is substantially all of the refracted light received at the focal point. In various examples, the different amount of the refracted light that is blocked is an amount of the refracted light that is less than the amount of refracted light that would be blocked if the refracted light were refracted at the expected angle of refraction. In various examples, MDL detection apparatus 300 is operable to transmit light from the point light source through a film product by directing the light from the point light source to a beam splitter, to redirect the light, by the beam splitter, to the film product for a first pass through the film product, and to redirect, by a converging mirror, the light back for a second pass through the film product.

Image sensing array 318 captures an electronic signal corresponding to variations of a level of light intensity received by the image sensing array for each of a plurality of image areas of the film product 220 (block 706), each of the plurality of image areas corresponding to an imaged line 308 on the film product 200, the image areas having a direction that is perpendicular to a direction of manufacturing used to manufacture the film product 220, and wherein the variations in level of light intensity received by the image sensing array result from variations in the angle of refraction of the light that exited the film product in the plurality of image areas of the film product.

In various examples, image capturing system 300 is further operable to move the film product in the direction that is perpendicular to a direction of manufacturing used to manufacture the film product to sequentially bring each of the plurality of image areas into an area of the film product currently being imaged, to image the image areas of the film product, and to mapping the imaged areas of the film product to the corresponding image captured for a portion of the film product that corresponds to the imaged area. In various examples, the image capturing system 300 is further operable to obtain a test sample of the film product by removing a crosswise strip of a film product from a web, to couple a first width edge of the test sample to a second widthwise edge of the test sample to form the test sample into a continuous loop, and to move the continuous loop of the test sample through an area where the transmitted light from a point light source is being provided to the film product in the direction that is perpendicular to the direction of manufacture of the film product from which the test sample was removed.

In various examples, system 300 performs analysis of the captured image to detect the presence of machine direction lines in the film product (block 708). In various examples, analysis of the captured image comprises analyzing the image to detect the presence of the machine direction lines in film product further comprising determining a pass/fail status for the film product based on quantifying image information included in the image generated from the film product; and comparing the quantified image information to one or more threshold values. In various examples, image capturing system 300 is operable to analyze the image to detect the presence of machine direction lines in the film product comprising detecting machine direction lines in the film product having a dimension of about 10 nanometers or greater. In various examples, the analysis of the image to detect the presence of machine direction lines includes quantifying a severity of a detected machine direction line.

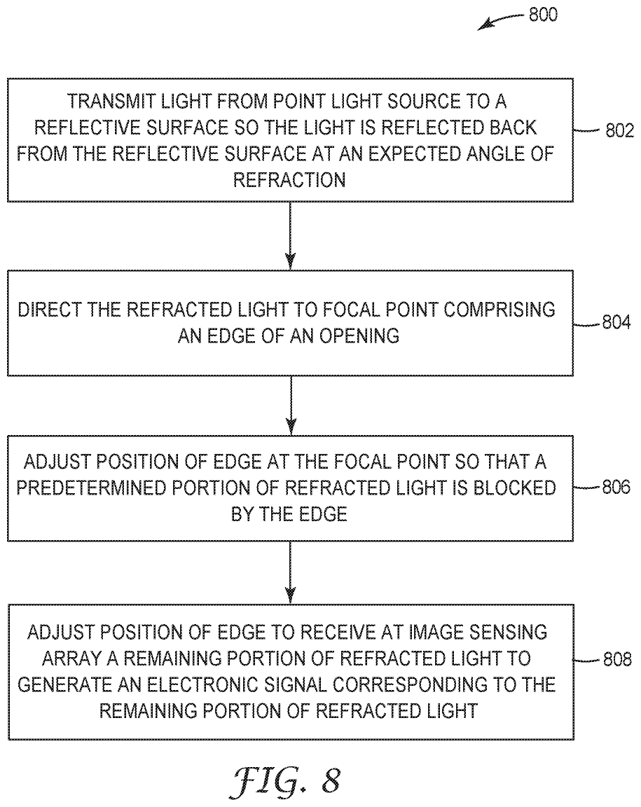

FIG. 8 is a flowchart illustrating one or more example methods 800 performed by an MDL detection apparatus in accordance with various techniques described in this disclosure. Although discussed with respect to MDL detection apparatus 300 as illustrated and described with respect to FIG. 3, the example methods 800 are not limited to the example implementations illustrated with respect to MDL detection apparatus 300 and FIG. 3. The techniques of example methods 800 can be implemented, in whole or in part, by MDL detection apparatus 114 as shown in FIG. 1, or by MDL detection apparatus 500 as shown in FIG. 5.

As illustrated in FIG. 8, point light source 302 transmits a light from a point light source, without passing the light through a film product, to a reflective surface of converging mirror 306 at a non-perpendicular angle of incidence to the mirror so that the light is reflected back from mirror 306 at an angle that corresponds to an expected angle of refraction, the light reflected at an angle of refraction equal to an expected angle of refraction the light would be refracted as if the light passed through and then exited a film product to generate a refracted light exited the film at the expected angle of refraction (block 802).

Lens 312 directs the reflected light, without passing the reflected light through a film product, to a focal point behind lens 312 (bock 804). In various examples, calibration of MDL detection apparatus 300 includes positioning an edge at the focal point so that a predetermined portion of the reflected light is blocked by the edge, and a remaining portion of the reflected light passed the edge through an opening adjacent to the edge (block 806).

In various examples, positioning the edge includes positioning the edge so that the remaining portion of the refracted light that passes the edge through the opening is received at an image sending array, wherein the amount of refracted light that passed the edge and arrives at image sensing array 318 generates an electronic signal corresponding to a level of light intensity that corresponds to a predetermined level of light intensity (block 808).

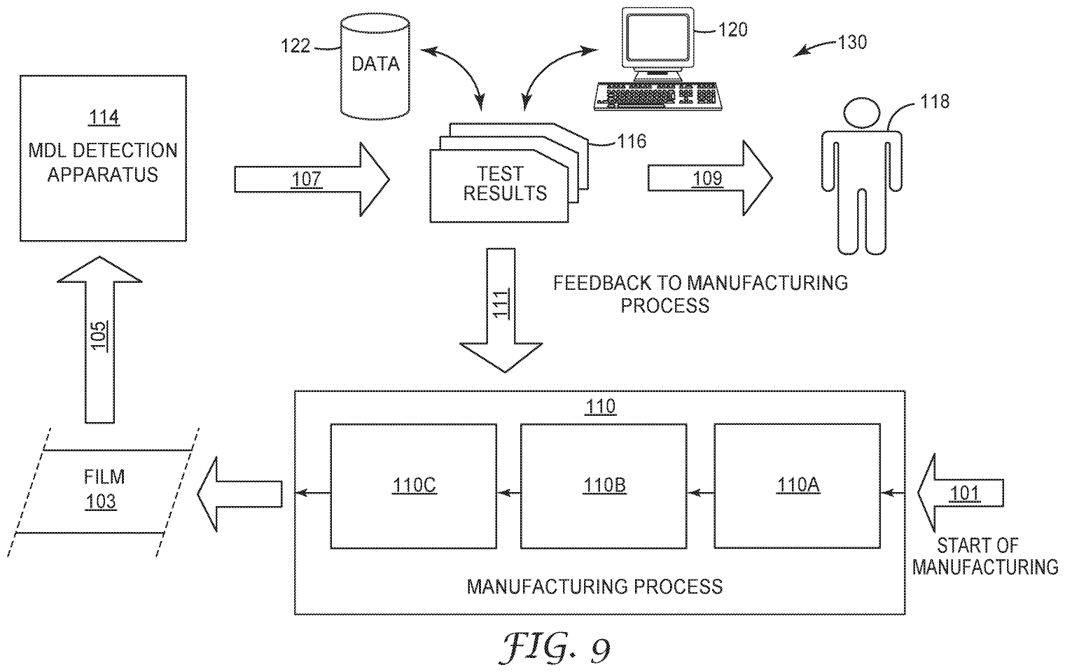

FIG. 9 is a block diagram illustrating an overview of another example system for manufacturing a film product, and testing the manufactured film product for MDL defects in accordance with one or more example implementations and techniques described in this disclosure. Items shown in FIG. 9 having a same reference number as shown in FIG. 1 correspond to the same or similar items as illustrated and described with respect to FIG. 1. For example, FIG. 9 includes manufacturing process 110 arranged to receive various inputs (e.g., material, energy, people, machinery, etc.) 101 and apply manufacturing processes 110A, 110B, and 110C, to produce film 103. Manufacturing process 110 is not limited to any particular type or form of manufacturing, and is illustrative of any type of manufacturing process configured to produce a film product that can include MDL defects, and that can be tested using any of the example implementations and techniques described herein for MDL defects.

The output of a film 103 as shown in FIG. 9 may consist of a film having a nominal thickness and a predetermined width dimension. The film can have a predetermined length, in most instances that can be many times longer than the width dimension, or can be provided from manufacturing process 110 in a continuous length, in either case which can be referred to as a web. In various examples, the film product(s) provided by manufacturing process 110 may comprises a single layer of transparent or semitransparent material, although other types of materials provided as output film 103 are contemplated as film products.

As shown in FIG. 9, system 130 includes an MDL detection apparatus 114 according to various example implementations and techniques described herein. Apparatus 114 may include any imaging device(s) that may be arranged to take images and to provide image data associated with a film product, such as film 103, according to any of the techniques described throughout this disclosure, including but not limited to the image capturing devices including the MDL detection apparatus 300 illustrated and described with respect to FIG. 3, and/or the MDL detection apparatus 500 illustrated and described with respect to FIG. 5. In various example implementations, MDL detection apparatus 114 includes use of a modified Schlieren imaging approach, described herein, to image film 103, and to detect fine changes (e.g., nanometer changes) of thickness of the film with respect to manufacturing process 110. In system 130, MDL detection apparatus 114 may perform various image processing techniques of the image data captured from film 103.

However, in contrast to system 100 as illustrated and described with respect to FIG. 1, in system 130 as illustrated in FIG. 9. instead of or in addition to taking a sample section from the film product to be tested using MDL detection apparatus 114, the apparatus 114 of system 130 may be arranged to image various portions of the film 103 in real time, and without the need to remove or otherwise separate a test sample portion of the film 103 from the web material forming the film product, although such test may still be subsequently performed in combination with the techniques described below. In system 130, the film 103 can be imaged by apparatus 114 in some examples in real time as the film is provided from the manufacturing process 110. As used in this disclosure, use of the term “real time” or a reference to “real-time” refers to the time required for processing circuitry to capture and analyze the image data, and may include the time required for the processing circuitry to generate graphical information for display that may be provided as a visual display of the graphical information on a display device, such as a computer monitor. The time frame associated with these “real time” or “real-time” references is not limited to any particular time period, and in some examples, capture and analysis of the image data may occur during a time span of as little as a few (e.g., 2 to 5 milliseconds), and up to 1 to 2 seconds. The time required for the processing circuitry to generate graphical information for display that may be provided as a visual display and to display the graphical information in some examples may occur during a similar or additional time span, for example within 2 to 5 milliseconds and up to 1 to 2 seconds following capture and analysis of image data. The capture, analysis of image data and the generation, and display of graphical information may proceed in real time for each image line, as further described below, as the image data for a given image line is captured.

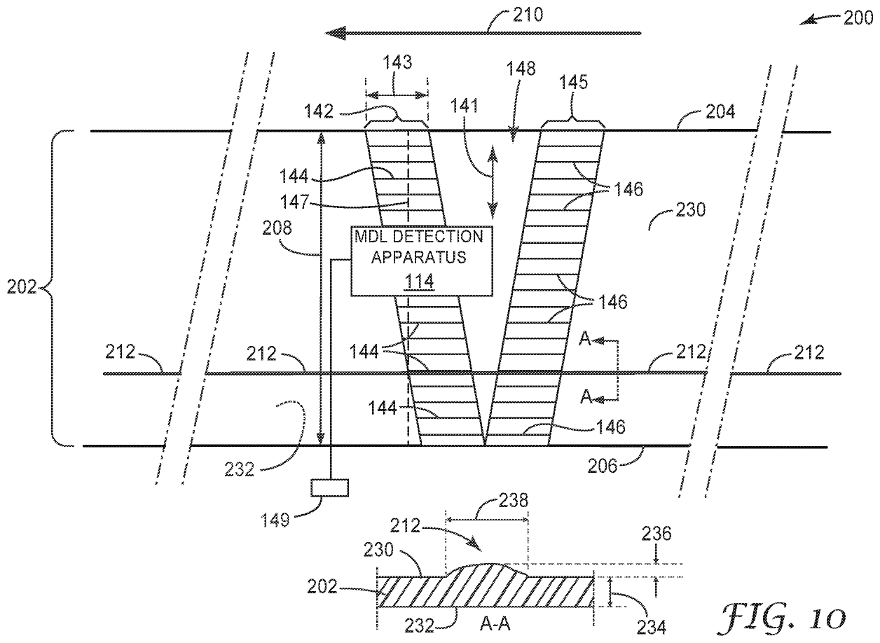

In some examples, apparatus 114 may configured to be positioned above a single layer of film 103, wherein apparatus 114 may be arranged to be movable in a crossweb direction relative to the width dimension of the film 103 so that apparatus 114 may image portions of the film 103 in a series of image lines parallel to one another and at various distances relative the edges of the film, and along various portions of the film throughout the length dimension of the film. Devices such as a conveying device and/or support surface (not shown in FIG. 9), may be arranged to provide movement of the film past the movable position where apparatus 114, but in a direction that is perpendicular to the direction of the movement of the apparatus. Examples of this type of scanning pattern that may be used by apparatus 114 to image the film 103 are further illustrated and described below with respect to FIG. 10.

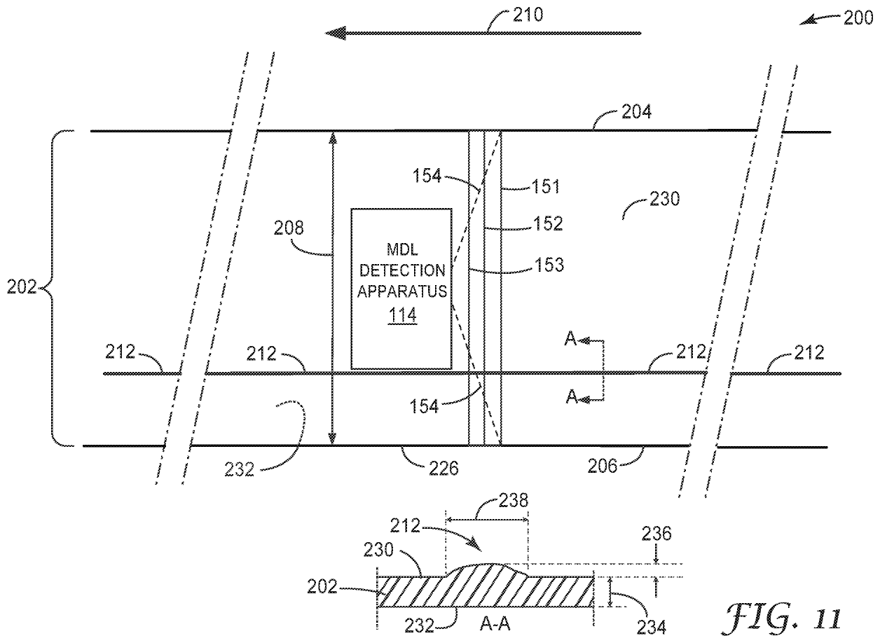

In other examples, apparatus 114 of system 130 as shown in FIG. 9 may be configured to be positioned above a single layer of film 103, wherein apparatus 114 may be arranged in a fixed position and arranged so that apparatus 114 can image the film 103 in image lines running perpendicular to the edges of the film, wherein devices such as a conveying device and/or support surface (not shown in FIG. 9), are arranged to provide movement of the film past the fixed position where apparatus 114 is located. The movement of the film 103 allows apparatus 114 to image the film in a series of parallel image lines along selected portions, or in some examples substantially the entirety, of length of the film product being provided as film 103 in system 130. Examples of this type of scanning pattern that may be used by apparatus 114 to image the film 103 are further illustrated and described below with respect to FIG. 11.

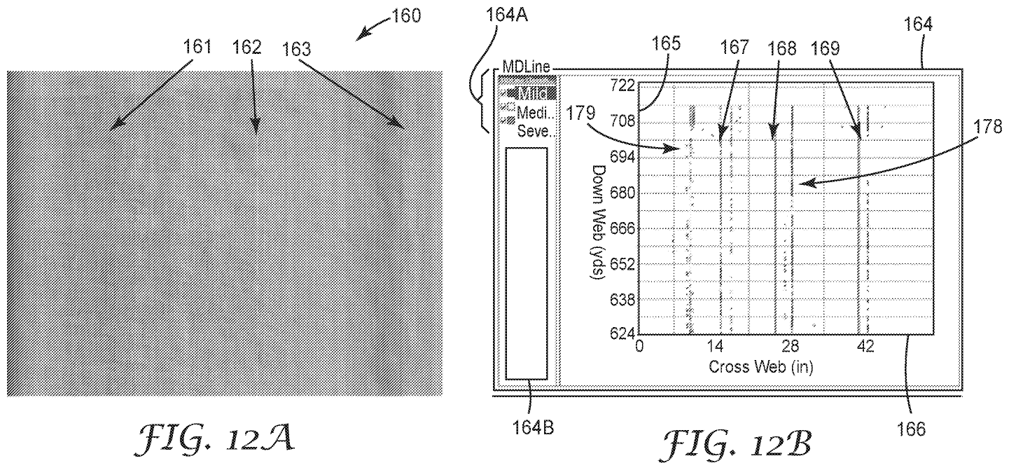

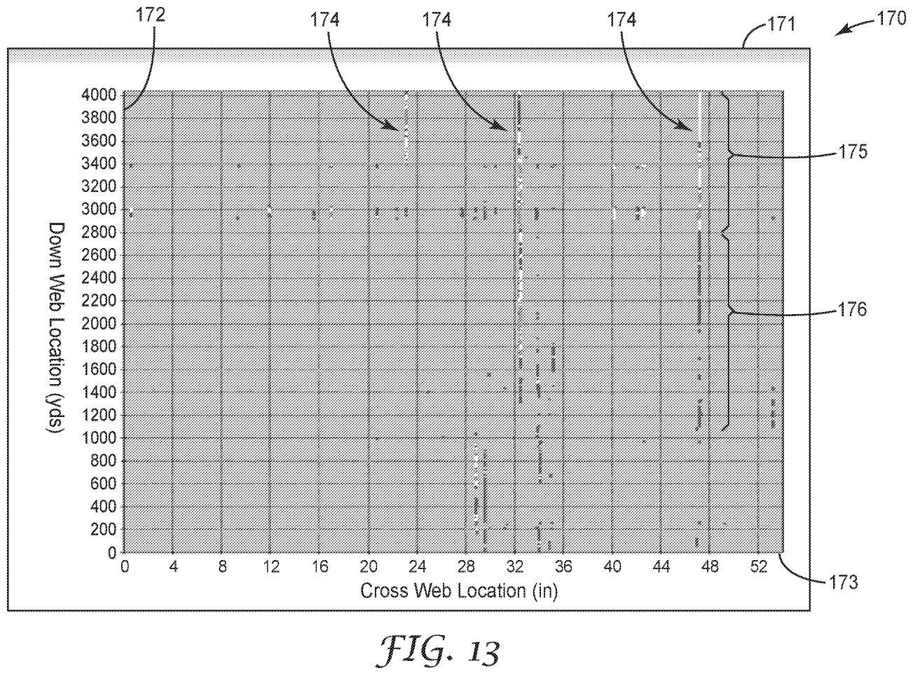

Referring again to FIG. 9, the imaging and image processing associated with MDL detection apparatus 114 is not limited to any particular type or technique of imaging or image processing. In various example implementations further described herein, image processing includes summing a quantity of a signal associated with a light intensity value received from imaging across each of a plurality of imaging lines that are imaged at various portions of film 103. In various examples, the imaging lines are lines that run across the web material forming film 103 in a direction that is perpendicular to a direction of the longitudinal axis of the film 103, and are thus also perpendicular to a direction the film product was conveyed in during manufacturing process 110. In other examples, the imaging lines are lines that parallel to one another and parallel to the edges of the web material forming film 103 in a direction that is a same orientation as the longitudinal axis (length dimension) of the film 103, and are thus are also parallel to a direction the film product was conveyed in during manufacturing process 110. In various examples, a graphical display of image data associated with a film product imaged using system 130 may include an MDL mapping of the detected MDL defects relative to the position(s) along the film where the defects were detected. Examples of graphical displays, including MDL mapping, are further described and illustrated below with respect to FIGS. 12A, 12B, and 13.

In system 130, MDL detection apparatus 114, and in various examples the image data capture and processing performed by MDL detection apparatus 114 provides output 107 including, for example, test results 116 representative of any MDLs introduced by manufacturing processes 110A-C. Test results 116 are not limited to any particular form or type of test results. In various examples, test results 116 include a graphical image resulting from the MDL detection apparatus 114 process, the graphical image comprising an image, or stored data representative of the captured image, that can be displayed and viewed, for example on a computer monitor of computer 120, by an operator 118. In various examples, test results 116 include graphical representations of the image information included in the captured image data associated with the imaging of film 103. Graphical representations of the image data are not limited to any particular type of graphical representations. In various examples, graphical representations include graphs having two-dimensional X-Y axis depicting variations in a signal over the surface of film 103, the signal indicative of a quantity of light received from each of the imaged rows of the film during the imaging of the test sample. In various examples, test results 116 include information based on statistical analysis of the data associated with the captured image of film 103, either in tabular format, or in a graphical format such as a graph illustrating a bell curve or other statistical distributions of the captured image data. In various examples, other information associated with film 103 may be included in test results 116. For example, information related to which shift the output of film 103 was made during, a date and/or time associated with the manufacturing of output film 103, what raw materials and/or machines were used in the production of output film 103, and what the environmental conditions were, such as ambient temperature of the area where and when output film 103 was manufactured, are examples of information that can be associated with the film 103, and can be included in test results 116. The information included in test results 116 is not limited to any particular type of information, and can include any information or types of information deemed to be relevant to the output film 103.

In various examples, test results 116 include a pass/fail indication with respect to detection of any MDL defects in film 103, and if present, the severity and frequency of any such detected defects. In various examples, the pass/fail indication is based on one or more parameters, thresholds, or rules that can be pre-set for determining the pass/fail status of output film 103 in view of the test results 116 associated with the film. In various examples, operator 118 is a technician, engineer, or other person who can inspect test results 116, and make a further determination regarding the status of output film 103 based on results of imaging film 103. Because the image data associated with imaging a film product such as film 103 in some examples is produced and made available in real time by system 130, an operator 118 may monitor the test results being generated and provided on a real-time basis. The ability to monitor the MDL detection in real time may provide several advantages. For example, the ability to monitor MDL defects in real time may provide early warnings for severe MD lines, allowing production to immediately stop producing unsaleable material, may result in deduced customer quality complaints stemming from intermittent die lines not identified in end-of-roll sample, and may provide direct material savings from film pull-back in a roll scraped for reject MDL defect. The ability to monitor MDL defects in real time may provide a capability to quantify defect severity levels during troubleshooting for steady-state MDL defects. Sorting the outputted film products by defect severity levels relative to MDL defects may allow classification of the suitability of the film products for particular uses where the severity of the MDL defects does not prevent the use of the film product in particular applications and/or products, but wherein the same level of severity of MDL defects may render the film product unfit for use in other applications and/or products. This ability to classify the level of defects in a given roll or batch of film products allows more use and less waste in the total output of product provide by a manufacturing system, such as manufacturing system 110 of FIG. 9. For example, operator 118 may render a pass/fail determination with respect to any MDL defects detected in film product relative to whether the output film 103 is of a quality level to allow further processing and shipment to customers.

In various examples, test results 116 are also configured to provide information 111 that can be used as feedback to manufacturing process 110 with respect to detecting MDL defects. For example, based on information 111 derived from test results 116, adjustments and/or repairs can be made to manufacturing process 110 in order to reduce or eliminate a level of MDL defects that might be generated as part of the manufacturing process 110, thus reducing potential defects and improving the quality of output of film 103 in batches of film products manufactured using manufacturing process 110. The processes illustrated for system 130 can be repeated at some regular interval, or at an interval determined for example based on test results 116. In some examples, imaging of the output film product may be performed one or more times for a given batch being provided as output film 103 from manufacturing process 110, or may be performed on a continuous basis throughout the outputting of a film product from manufacturing process 110. In various examples, the interval used to determine when imaging of the output film 103 is to be performed may be determined by a frequency, severity, or both a frequency and the severity of MDL defects being detected in one or more portions of film 103. In various examples, imaging of the output of a film product may be performed when repairs and/or adjustments are made to manufacturing process 110, and as the first output is then being provided as film 103 from manufacturing process 110 following any such repairs or adjustments. In various examples, imaging of the output of a film product may be performed when a new material is provided at start of manufacturing 101, and the first batch of film 103 is provided from manufacturing process 110 comprising the new material, the captured image information used to evaluate the new material and the film product produced using the new material for the presence, frequency, and severity of any detectable MDL defects.

Imaging of film products using system 130 is not limited to imaging of the film product at the time of manufacture, and may be performed on a film product at any time following the manufacturing of the film product. For example, the output film provided by manufacturing process 110 may be formed into rolls or otherwise stored, and retrieved later for processing using MDL detection apparatus 114 in order to determine if the finished film product includes MDL defects, and if so, the severity and/or location(s) of the defects. In various examples, the image data associated with a roll, batch or other quantity of film product may be stored in a database, such as data 122 as shown in FIG. 9, wherein the data can be associated with the film product from which the data is derived, for example using lot number, roll number, data/time of manufacture, customer and/or shipping numbers.

System 130 includes one or more devices configured to store any of the information described above, including test results 116, as data 122 stored in a database, in some examples in the form of a relational database, or in any other type of system or device configured to store test results and any other associated information in a retrievable format. In various examples, data 122 is stored in an electronic database, located either on-site where manufacturing process 110 is taking place, or may be a remote databased coupled to test results 116 via a network, such as the internet or through a local network. In various examples, data 122 represents printed materials stored in a location, such as a file room.

In any of the systems and methods described through this disclosure, one or more processors and/or one or more sets of processing circuitry may perform some, any, and/or all of the functions attributed to the systems and methods described herein. These features and functions may include, but are not necessarily limited to, control of the conveying device(s) used to move the film product, control of the device(s) that may be used to position the MDL detection apparatus, control of the image capturing processes performed by an image capturing device, performing analysis of the captured image data, storage of the captured image data, including storage, accessing, and manipulation of a database such as a relational database, generation of graphical information related to the display of the information associated with the image data. Analysis of the captured image data and display of the graphical information may include detection of MDL defects within the imaged film product, and generation of graphical information that graphically depicts the detected MDL defects. The location of the processor(s) and/or the processing circuitry is not limited to any particular location or to any particular device(s), and may be located in one or more devices, including but not limited to computer 120 and/or MDL detection apparatus 114 as shown in FIG. 9.

FIG. 10 is a conceptual diagram illustrative of a top view of an example portion of a film product illustrating an imaging technique in accordance with one or more example implementations and techniques described in this disclosure. Items shown in FIG. 10 having a same reference number as a shown in FIG. 2 correspond to the same or similar items as illustrated and described with respect to FIG. 2. For example, as shown in FIG. 10, a top view of an example portion of a film 202 produced by a manufacturing process (such as film 103 produced by manufacturing process 110) is provided, the film 202 having a first edge 204, a second edge 206 substantially parallel to first edge 204, and a width dimensions 208 between first edge 204 and second edge 206. In various examples, the value for width dimension 208 is substantially equal along an entire length dimension of film 202. The length dimension of film 202 in some examples is an indeterminate length that is many times longer than the value for width dimension 208. Film 202 includes a planar top surface 230, and a planar bottom surface 232 that is substantially parallel to top surface 230. In a similar manner to that described with respect to FIG. 2, arrow 210 as shown in FIG. 10 shows a direction that the film 202 is moving, for example along a web support/conveying mechanism (not specifically shown in FIG. 10), in a direction parallel to the longitudinal axis (length dimension) of the film. Film 202 may include one or more MDL defects, illustratively represented by MDL line 212 in FIG. 10.

As illustrated in FIG. 10, the MDL detection apparatus 114 is positioned over film 202 at a position represented by dashed line 147, wherein the position is fixed relative to the longitudinal axis (length dimension) of film 202, and relative to any movement of film 202 in the direction indicated by arrow 210. Apparatus 114 may include any imaging device(s) that may be arranged to take image data associated with a film product, such as film 202, according to any of the techniques described throughout this disclosure, including but not limited to the MDL detection apparatus 300 illustrated and described with respect to FIG. 3, and MDL detection apparatus 500 illustrated and described with respect to FIG. 5. In addition, apparatus 114 may be configured to allow apparatus 114 to be moved back and forth widthwise, (e.g., in a direction parallel to width 208 and perpendicular to the length dimension of film 202), the directions of movement of apparatus 114 indicated by arrow 141. In various examples, a device 149, for example a robot, is mechanically coupled to apparatus 114, and is arranged to provide and physically control the positioning of apparatus 114 along the axis across the film 202 at the position represented by dashed line 147. Device 149 may be arranged to position apparatus 114 at any position along dashed line 147, and including positions the extend beyond either of both of edges 204 and 206 of the film, to position apparatus 114 so that apparatus 114 may image the film 202 using the imaging patterns along tracks 142 and/or 145 as further described below. For example, due to the angle of incidence of the light rays provided to and refracted from film 202 utilized during the imaging of film 202, apparatus 114 may be required to be positioned at a point outside the edge 204 and/or outside the edge 206 of the film, at least with respect the one or more of the image lines taken when imaging film 202 using the image patterns of tracks 142 and/or 145.

In various examples, control of the movements of apparatus 114 to produce image data associated with the images of film 202 within tracks 142 and 145 may be provided by apparatus 114, and communicated to device 149. In other example, device 149 provides the control of the positioning of apparatus 114, for example using processing circuitry and programing that may be stored in device 149. In various examples, control commands for the positioning of apparatus 114 may be provided to device 149 and/or to apparatus 114 based on commands and/or instructions received from another computer device, such as computer 120 illustrated and described what respect to FIG. 9.

In operation, during the imaging process illustrated in FIG. 10, film 202 is conveyed in a direction along the longitudinal axis (length dimension), as generally indicated by arrow 210. As the film is being conveyed (moved), apparatus 114 is positioned at a series of different positions along the position illustrated as dashed line 147. At each position, apparatus 114 may be triggered to image film 202 along an image line, such as one of image lines 144 along track 142. After imaging the film 202 at a given position, data associated with the image line is captured, and apparatus 114 is moved some incremental amount in a direction along dashed line 147. Once the apparatus 114 has arrived at the next subsequent position, apparatus 114 is again triggered to image film 202 along another image line, the subsequent image line being parallel to the previous image line, and at some distance from the portion of the film 202 where image data for the previous image line was taken. This alternate pattern of positioning apparatus 114, imaging film 202 and repositioning apparatus 114 may be repeated over some number of times in order to generate a set of image line data that extends for example across the width of film 202. For example, a set of image lines, illustratively represented by lines 144, may be imaged by apparatus 114, extending from edge 204 to edge 206 of film 202, and falling within a skewed track, generally indicated by bracket 142.

As illustrated in FIG. 10, the film 202 is being conveyed in the direction of arrow 210 during the time when apparatus 114 is being positioned and repositioned relative to the width dimension of film 202 and performing the imaging of the film. As a result, the track 142 has a skewed pattern, wherein the image lines 144 nearest edge 204, which for example were taken first in the sequence of imaging process, are further downstream, (e.g., more to the left in FIG. 10), and the image lines 144 closer to edge 206 are more upstream (e.g., more to the right in FIG. 10). Because apparatus 114 is operating in a fixed position relative to the movement of film 202 in the example illustrated in FIG. 10, the amount of skew that is imparted into track 142 is a function of the speed at which the film 202 is being conveyed, and the time used to position apparatus 114 and perform the imaging at the various positions along dashed line 147.

In various examples, after completion of a track of image lines, such as image lines 144 included in track 142, the positioning of apparatus 114 continues, but in a pattern starting at edge 206, and progressing toward edge 204 of film 202, including imaging film 202 at the various positions were apparatus 114 may be positioned along dashed line 147. As illustrated in FIG. 10, this process of moving and imaging in a direction from edge 206 toward edge 204 may provide a series image lines illustratively shown as image lines 146, distributed in parallel to one another and provided along a portion of film 202 illustratively shown as track 145. Again, due to the movement of film 202 that is occurring during the imaging process used to image the film shown within track 145, track 145 is skewed in a similar manner as described above with respect to track 142. However, with respect to track 145 the image lines 146 that are nearest edge 206, which for example were taken first in the sequence image lines included in track 145, are further downstream, (e.g., more to the left in FIG. 10), and the image lines 146 closer to edge 204 are more upstream (e.g., more to the right in FIG. 10). Again, because apparatus 114 is operating in a fixed position relative to the movement of film 202 in the example illustrated in FIG. 10, the amount of skew that is imparted into track 145 is a function of the speed at which the film 202 is being conveyed, and the time used to position apparatus 114 and perform the imaging at the various positions along dashed line 147.

The width of tracks 142 and/or 145, for example as illustrated by width dimension 143 of track 142, is not limited to any particular dimension, and may be a function of the imaging device 114. In some examples, this width dimension may be in a range of 6 to 48 inches. In some examples, the width dimension may be a programmable variable, and may be provided as a user input to apparatus 114, for example by a user such as user 118 using computer 120 as shown in FIG. 9. As illustrated in FIG. 10, the pattern of image lines 144, 146 provided using the above described technique may result in blank areas 148 of film 202 that lie between the image lines, and are not directly imaged by apparatus 114. However, as shown in FIG. 10, the MDL defect illustrated in FIG. 10 as MDL 212 is imaged, at least over some portion of the defect, by image lines included in both track 142 and track 145. The amount of spacing including in blank areas 148 may be controlled and for example limited by controlling various parameters of the system, such as the speed at which the film 202 is conveyed, the speed of movement of apparatus 114 between imaging positions, the width dimension of film 202, and the number of times and/or spacing between image lines within a track. The number of image lines taken across the width dimension of film 202, and the spacing between image lines within a given track is not limited to any particular number and/or any particular spacing, and may be programmable parameter(s) that may be set based for example upon user inputs.

Using the pattern of image lines illustrated in FIG. 10, image data may be captured for portions of film 202 along some length, or in some examples along substantially the entire length of a film 202. The captured data may be process using any of the methods and techniques described in this disclosure, or any equivalents thereof. The captured data may be used to generate image data, which may be provided, for example in a graphical form on a display, such as a computer monitor, in real time as the image data is being captured. The captured data may be used to generate a MDL defect map that maps detected MDL defects detected in film 202 to the location(s) of the defect(s) within the film, and may provide additional information, such as information indicative of the severity of the defect or defects at various locations along the film. In addition, the captured data may be stored for later retrieval and/or review.

The image lines, spacing, angles of skew of tracks, and the depiction of apparatus 114 are intended to be illustrative of the concepts described with respect to FIG. 10, and are not intended to be to scale, or to represent for example the actual dimensions of actual image lines or tracks of image lines that may be used to capture image data for a given film product. In various examples, these parameters, including the length and/or spacing of the image line 144, 146 may be programmed or adjusted in accordance with various factors, such as the type of film product to be imaged, the types and severities of the defect(s) that need to be detected, and the speed(s) at which the imaging and processing of image data can be performed. In some examples, imaging of the film 202 may only be performed in one direction of movement of apparatus 114, for example imaging from edge 204 toward edge 206 only, or from edge 206 to edge 204 only. In some examples, the tracks of image lines need not be continuous so as to be in contact with each other at any point of the track. For example, after completion of the imaging used to provide image lines 144 of track 142, a pause in time may be taken before proceeding with imaging used to produce the image lines 146 of track 145. During this pause period, the film 202 may continue to be conveyed in the direction of arrow 210, thus creating a space along edge 206 between the last image line 144 of track 142 and the first image line 146 included in track 145. Following completion of the imaging producing image lines 146 and track 145, imaging may continue immediately or after a pause in time, and may generate any additional number of image lines and tracks as film 103 continues to be conveyed past the areas where MDL detection apparatus 114 is located.

FIG. 11 is a conceptual diagram illustrative of a top view of an example portion of a film product illustrating another imaging technique in accordance with one or more example implementations and techniques described in this disclosure. Items shown in FIG. 11 having a same reference number as a shown in FIG. 2 correspond to the same or similar items as illustrated and described with respect to FIG. 2. For example, as shown in FIG. 11, a top view of an example portion of a film 202 produced by a manufacturing process (such as film 103 produced by manufacturing process 110) is provided, the film 202 having a first edge 204, a second edge 206 substantially parallel to first edge 204, and a width dimensions 208 between first edge 204 and second edge 206. In various examples, the value for width dimension 208 is substantially equal along an entire length dimension of film 202. The length dimension of film 202 in some examples is an indeterminate length that is many times longer than the value for width dimension 208. Film 202 includes a planar top surface 230, and a planar bottom surface 232 that is substantially parallel to top surface 230. In a similar manner to that described with respect to FIG. 2, arrow 210 as shown in FIG. 10 shows a direction that the film 202 is moving, for example along a web support/conveying mechanism (not specifically shown in FIG. 10), in a direction parallel to the longitudinal axis (length dimension) of the film. Film 202 may include one or more MDL defects, illustratively represented by MDL line 212 in FIG. 11.

As illustrated in FIG. 11, the MDL detection apparatus 114 is positioned over film 202 at a fixed position relative to both edge 204 and edge 206 of the film, and relative to the longitudinal axis (length dimension) of film 202, and thus also relative to any movement of film 202 in the direction indicated by arrow 210. Apparatus 114 may include any imaging devices that may be arranged to take image data associated with a film product, such as film 202, according to any of the techniques described throughout this disclosure, including but not limited to the MDL detection apparatus 300 illustrated and described with respect to FIG. 3, and MDL detection apparatus 500 illustrated and described with respect to FIG. 5. Apparatus 114 may be arranged in a position over film 202 that allows apparatus 114 to capture light rays, illustratively represented by dashed lines 154, which may be associated with a plurality of image lines, such as image lines 151, 152, and 153 as shown in FIG. 11. As shown in FIG. 11, each of the image lines 151, 152, and 153 is parallel to one another, and extend in a lengthwise direction that is perpendicular to edge 204 and edge 206, and is also perpendicular to the longitudinal axis (length dimension) of film 202, and thus is also perpendicular to the direction of motion of film 202 as represented by arrow 210. The length dimension of image lines 151, 152, and 153 in some examples may be equal to the width dimension 208 of film 202, such that each image line extends substantially from edge 204 to edge 206 of film 202. In other examples, the length of the image lines may be less than the width dimension 208. In such instances, apparatus 114 may be configured to be positioned at different distances between edges 204 and 206 so that at various times, portions of the film 202 relative to the edges may be imaged by apparatus 114 using a positioning device (not specifically shown in FIG. 11) such as device 149 illustrated and described with respect to FIG. 10.

In operation, during the imaging process illustrated in FIG. 11 film 202 is conveyed in a direction along the longitudinal axis (length dimension), as generally indicated by arrow 210. As film 202 is conveyed beneath apparatus 114, apparatus 114 may be triggered, for example at some predetermined rate. When triggered, apparatus 114 may be configured to image a portion of film 202 to generated image data associated with an image line, such as image line 153. As the film is conveyed in the direction of arrow 210, the apparatus 114 may be again trigger, and when triggered the apparatus 114 may be configured to image a portion of film 202 to generated image data associated with another and subsequent image line, such as image line 152. As illustrated in FIG. 11, the image data associated with image line 152 is captured at some time following the capture of the image data associated with image line 153, and thus is associated with a portion of film 202 that is upstream (e.g., more to the right in FIG. 11), relative to image line 153.

As film 202 continues to be conveyed beneath apparatus 114, apparatus 114 may be triggered at some time following the triggering and capturing of data associated with image line 152. When again triggered, apparatus 114 may be configured to image a portion of film 202 to image and capture image data associated with a further subsequent image line, such as image line 151. As illustrated in FIG. 11, the image data associated with image line 151 is captured at some time following the capture of the image data associated with image line 153 and image line 152, and thus is associated with a portion of film 202 that is upstream (e.g., more to the right in FIG. 11), relative to both image line 153 and image line 152.

This pattern of moving the film and triggering apparatus 114 to capture image data associated with an image line positioned at an upstream portion of the film 202 relative to the last captured image line may be repeated over some number of times in order to generate a set of image line data that extends for example at intervals extending along some portion of the length dimensions of film 202, or in some examples over substantially the entirety of the length dimension of film 202. In examples where the length dimension of the image lines 151, 152, 153 extend between edge 204 and 206 of the film 202, and using some predefined trigger interval to trigger apparatus 114, imaging of the film 202 covering the entirety of the film 202 as some level of resolution may be possible. For example, image data associated with image lines such as image lines 151, 152, and 153 extending from edge 204 to 206 may be captured at some interval or intervals along some portion, or in some examples over the entirety of the length dimension of film 202, thus providing image data, at least at some level of resolution, over the entirety of the length dimension of film 202.

The length dimension of image lines 151, 152, and 153 is not limited to any particular dimension, and may be a function of the imaging device 114. In some examples, this length dimension may be in a range of 6 to 48 inches, and may be set based on the width dimension 208 of the film 202 so that the length dimension of the image lines extends at least from edge 204 to edge 206 of the film. In some examples, the length dimension of the image lines may be a programmable variable, and may be provided as a user input to the system, for example by a user such as user 118 using computer 120 as shown in FIG. 9. As illustrated in FIG. 11, the pattern of image lines 151, 152, 153 may be repeated, at one or more distance intervals along the longitudinal axis of the film 202. As shown in FIG. 11, the MDL defect illustrated in FIG. 11 as MDL 212 is imaged at least over some portion of the defect, by each of the image lines 151, 152, and 153. As such, changes in the location and/or changes in the severity level of the MDL defect may be tracked using the image data captured for each of the image lines, and for additional image data captured from image lines (not specifically shown in FIG. 11) along other portions of the length of the film.

The amount of spacing along the longitudinal axis between image lines, such as image lines 151, 152, and 153, may be controlled by controlling various parameters of the system, such as the speed at which the film 202 is conveyed and the rate at which apparatus 114 is triggered to capture image data. The number of image lines taken across the width dimension of film 202 is not limited to any particular number and/or any particular spacing, and may be programmable parameter(s) that may be set based upon user inputs. Using the pattern of image lines illustrated in FIG. 11, image data may be captured for portions of film 202 along some length, or in some examples along substantially the entire length of a film 202. The captured data may be process using any of the methods and techniques described in this disclosure, or any equivalents thereof. The captured data may be used to generate image data, which may be provided, for example in a graphical form on a display, such as a computer monitor, in real time as the image data is being captured. The captured data may be used to generate a MDL defect map that maps detected MDL defects detected in film 202 to the location(s) of the defect(s) within the film, and may provide additional information, such as information indicative of the severity of the defect or defects at various locations along the film. In addition, the captured data may be stored for later retrieval and/or review.

The image lines, the spacing between the image lines, and the depiction of apparatus 114 are intended to be illustrative of the concepts described with respect to FIG. 11, and are not intended to be to scale, or to represent the actual dimensions of actual image lines that may be used to capture image data for a given film product. In various examples, these parameters, including the length and/or spacing of the image lines 151, 152, and 153 may be programmed or adjusted in according with various factors, such as the type of film product to be imaged, the types and severities of the defect that need to be detected, and the speed(s) at which the imaging and processing of image data can be performed. In some examples, the image data associated with a set or a group of image lines may be continuous with another set or group of image lines at different positions relative to the length dimension of the film. For example, a set of image data associated with image line(s) may be capture, followed by a pause in the triggering of the apparatus 114 while the film 202 continues to be conveyed in the direction indicated by arrow 210. Following this pause, triggering of apparatus 114 may resume, resulting in capturing of image data associated with image line(s) that are separated from the previously imaged set or group of image lines by some distance along the length dimension of the film 202. The separation dimensions may be larger than the distance between the positions of the image liens within a same set or group of image lines. Using this technique, sets or groups of image lines, spaced apart from one another, may be used to capture image data at some interval or intervals along the length dimension of the film 202. The interval or intervals may be a programmable parameter, and may be determined for example by user inputs provided to apparatus 114. Using this spacing technique, the total amount of processing required may be reduced, and/or the rate at which the film 202 may be imaged may also be increased, while still providing adequate imaging of the film to detect MDL defects that may exist over various portion of the film.

FIG. 12A illustrates an example image 160 that can be generated from imaging a film product in accordance with one or more example implementations and techniques described in this disclosure. Image 160 may be generated from captured image data generated using any of the methods and techniques described herein. For example, image 160 may be generated from image data captured using a scanning pattern comprising image lines oriented in a same direction as the longitudinal axis (length dimension) of a film product and captured using a scanning pattern as illustrated and described with respect to FIG. 10. In another example, image 160 as illustrated in FIG. 12A may be generated from image data captured using a scanning pattern comprising image lines oriented in a cross-web direction, e.g., oriented perpendicular to the length dimension of the film, and captured using a scanning pattern as illustrated and described with respect to FIG. 11.

In various examples, image 160 is representative of image data being captured in real time, and for example being displayed on a display device, such as a computer monitor, in real time. As shown in FIG. 12A, various MDL defects 161, 162, 163 appear in the portion of the film being represented by image 160. Examples of another form of a graphical display representative of MDL defects 161, 162, and 163 are further illustrated and described below with respect to FIG. 12B.

FIG. 12B illustrates an example of graphical information 164 that may be generated from imaging a film product in accordance with one or more example implementations and techniques described in this disclosure. Graphical information 164 may be displayed on a display device, such as a computer monitor. In addition, user and/or system generated inputs provided to a computer, such as computer 120 illustrated and described with respect to FIG. 9, may be provided to control the display of graphical information 164 and/or to provide inputs to the imaging system that may be capturing the graphical information 164 in real time, as further described below.

As shown in FIG. 12B, graphical information 164 includes a vertical axis 165 representing down web distances in yards, and a horizontal axis 166 representing cross web dimensions in inches. The upper most horizontal line perpendicular to the vertical axis 165, indicated by yardage value “722” in some examples represents the latest real-time data associated with image data being captured from imaging a film product. The additional portion of the graph below the “722” line represents older data captured from the downstream portion of the same film product, at the positions indicated by the yardage values along vertical axis 165. The data provided in graphical information 164 along horizontal axis 166 is representative of image data captured at different positions of the film product relative to the width dimension of the film product, as indicated as the cross web (width dimensions) depicted along the horizontal axis 166. Graphical information 164 includes a depiction of the MDL defects 161, 162, 163 illustrated in image 160 of FIG. 12A, by the lines 167, 168, 169, respectively, illustrated in graphical information 164. In various examples, different colors may be used as part of the display provide by graphical information 164 to indicate the severity of the MDL defect. For example, lines 167, 168, 169 may be depicted in graphical information 164 using a red color, indicative of MDL defects that meet a threshold level classified as a “severe” defect. Additional indications of less severe MDL defects may be provided using different colors. For example, the line generally indicated by arrow 178 in FIG. 12B may be provided in a blue color, indicative of a MDL defect classified as a “mild” defect, and portions of the MDL defect generally indicated by arrow 179 in FIG. 12B may be provided in a yellow color, indicative of a MDL defect this is classified as a “medium” level defect.

Thus, the presence of MDL defects, and the level of severity of any such defects may be displayed, in some examples in real time, which allows a user to visually monitor the detection of the defects present in a film product, for example as the film is being provided from the manufacturing process(es). In various examples, detection of an MDL defect having a particular level of severity may cause the system to generate an alarm, such as a visual indication on the display, and/or an audio alarm. The alarm may be used to alert a user of the detected MDL defect, so the user may take appropriate action, for example to stop the manufacturing process that is providing the defective film, and take corrective action to prevent further losses in the production process. In some examples, the generation of the alarm may be configured to automatically stop the manufacturing process that is providing the defective film product in addition to providing an alert output to a user regarding the detection of the MDL defect(s).

In various examples, block 164A includes a key, which may be a color-coded key, which is provided a part of graphical information 164. As shown in FIG. 12B, the items currently included in the block 164A include a selection for indicating “mild,” “medium” and “severe” levels of MDL defects as a part of the display. In various examples, the items in the key may be selectable or unelectable based on user inputs, and thus allow a user to control the level and/or types of defects being displayed as part of graphical information 164 at any given time. For example, only MDL defects that fall into one of the selected categories in block 164A may be provided in the display of graphical information 164.

Graphical information 164 may also include an additional display portion 164B that provides information and/or allows a user to provide inputs to a system, such as system 130 illustrated and described with respect to FIG. 9, and that is being used to capture image data associated with a film product, and/or to manipulate the information being displayed as graphical information 164. For example, display portion 164B may include editable text fields, as would be understood by one of ordinary skill in the art, that allows a user to enter information related to the threshold level or levels used to define the “severe,” “medium,” and “mild” MDL defects. Inputs provided to display portion 164B may also be used to provide system operation parameters, such as rates for conveying a film product being imaged, positioning information related to the positioning of an MDL imaging apparatus, and/or triggering rates/interval associated with the trigger of an MDL imaging apparatus to capture image data associated with a film product. Additional inputs provided through display portion 164B may allow a user to control the display being provided by graphical information 164, such as the resolution of either or both of the vertical axis 165 and the horizontal axis 166, for example to allow a user to zoom in on a particular portion of the graphical information 164, or to zoom out the view being provided as graphical information 164. Inputs to the display portion 164B may allow a user to view older image data that may have scrolled off the display due to the incoming new image data.

The types of information that may be displayed as part of display portion 164B and that may allow user to provide inputs to the system are not limited to any particular types of information or to any particular types of inputs, and may include any types of information relevant to the imaging of the film product and may including any types of user inputs that may be deem needed to control the display of data and/or to control the operation of the imaging system.

FIG. 13 illustrates another example of graphical information 170 that can be generated from imaging a film product in accordance with one or more example implementations and techniques described in this disclosure. In various examples, graphical information may be displayed on a display device 171, such as a computer monitor of another type of display screen. As shown in FIG. 13, graphical information 170 includes a vertical axis 172 indicative of down web locations in yards, and a horizontal axis 173 indicative of cross web locations in inches. Graphical information 170 further includes graphical indications of the presence of MDL defects, generally depicted by lines 174, that were detected by imaging a film product associated with the portion of the film product identified by the ranges of values indicated by the vertical and horizontal axes 172, 173, respectively. In some examples, graphical information 170 illustrates the detected MDL defects for the entirety of a film product, such as a particular roll of film. In some examples, graphical information 170 is generated using image data, for example image data store in a database that was captured at some time prior to the generation of graphical information 170. In some examples, graphical information 170 represents image data being captured in real time, wherein the upper most portion of the graphical information 170 along a horizontal line above the “4000” mark of the vertical axis 172 represents the most recently captured image data. In a manner similar to that described above with respect to graphical information 164, various colors may be displayed as part of graphical information 170 to indicated various level of severity of the MDL defects, including the MDL defects generally indicated by lines 174.

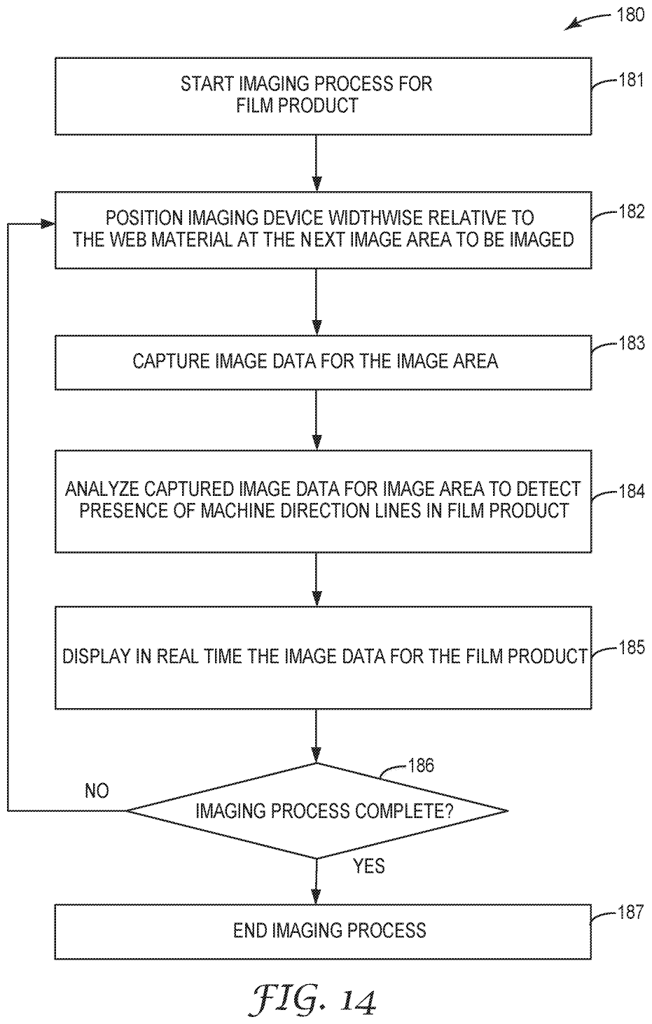

FIG. 14 is a flowchart illustrating one or more example methods 180 performed by an MDL detection apparatus in accordance with various techniques described in this disclosure. Although discussed with respect to system 130 and MDL detection apparatus 114 as illustrated and described with respect to FIG. 9, the example methods 180 are not limited to the example implementations illustrated with respect to MDL detection apparatus 114 and FIG. 9. The techniques of example methods 180 can be implemented, in whole or in part, by MDL detection apparatus 114 as shown in FIG. 1, by MDL detection apparatus 500 as shown in FIG. 5, by MDL detection apparatus 114 as shown in FIG. 10.

As illustrated in FIG. 14, system 130 starts an imaging process for imaging a film product (block 181). Starting the imaging process may including moving, for example using a conveying device, at least a portion of a film product comprising a single layer of film having a width dimension and a length dimension in a first direction parallel to the length dimension, the first direction parallel to a direction of manufacturing used to manufacture the film product. After starting the imaging process, system 130 positions imaging apparatus 114 widthwise relative to the web material (block 182). Positioning apparatus 114 may include positioning apparatus 114 at a next image area of the film product to be imaged. Once positioned, apparatus 114 may be triggered to capture image data for the image area (block 183). Method 180 further includes analyzing the captured data from the image areas to detect the presence of any MDL defects in the film product within the image area (block 184). Analysis of the image data may include analysis using any of the techniques and/or methods described throughout this disclosure, and/or any equivalents thereof, to detect the presence of MDL defects using the capture image data.

Methods 180 may further include displaying the captured image data for film product (block 185). Displaying the captured image data at may include displaying the captured image data in real time. Display of the captured image data is not limited to any particular format or type of display, and may include any type of graphical display of information, including display of graphical information as illustrated and described with respect to any of FIGS. 12A, 12B, and 13.

Referring again to FIG. 14, following capture of image data for the image area associated with the position of apparatus 114, methods 180 may determine whether the image processing has been completed (block 186). In response to a determination that the imaging process has not been completed, (the “NO” branch extending from block 186), method 800 returns to block 182, wherein system 130 repositions apparatus 114 to a new position widthwise relative to the web material, to allow imaging of a next image area of the film product being images. In some examples, the sequence of repositioning (block 182) and capturing image data for a new image area associated with the new position of the apparatus 114 (block 183) may be repeated for a number of times. The image data captured for each image area may be analyzed (block 184) and/or displayed (block 185) until system 130 determines that the imaging process has been completed (the “YES” branch extending from block 186).

A determination that the imaging process has been completed may be made based on a determination that the end of the film product being imaged has been reached. In some examples, a determination that the imaging process has been completed may be made based on a determination that a threshold level of MDL defects is being detected by the imaging process of the film product being images. A threshold level of MDL defects being detected may be based on a threshold number of MDL defects being detected within a defined period time, by a level of the severity of the MDL defects being detected, or some combination of the number and the severity level of the detected MDL defects. In response to a determinate that the imaging process has been competed, system 130 ends the imaging process (block 187).

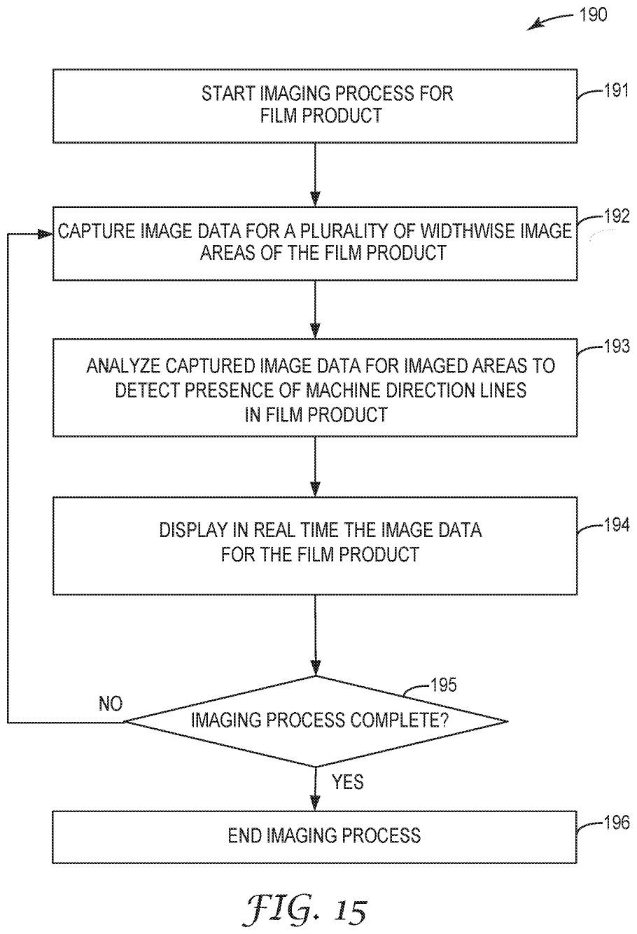

FIG. 15 is a flowchart illustrating one or more example methods 190 performed by an MDL detection apparatus in accordance with various techniques described in this disclosure. Although discussed with respect to MDL detection apparatus 114 as illustrated and described with respect to FIG. 9, the example methods 190 are not limited to the example implementations illustrated with respect to MDL detection apparatus 114 and FIG. 9. The techniques of example methods 180 can be implemented, in whole or in part, by MDL detection apparatus 114 as shown in FIG. 1, by MDL detection apparatus 500 as shown in FIG. 5, by MDL detection apparatus 114 as shown in FIG. 11.

As illustrated in FIG. 15, system 130 starts an imaging process for imaging a film product (block 191). Starting the imaging process may include positioning an image capturing device, such as MDL detection apparatus 114, so that each of the plurality of image areas to be imaged comprises an image line having an image line length that is perpendicular to the length dimension of the portion of the film product and is parallel to the width dimension of the portion of the film product so that the image line length extends across the entirety of the width dimension of the portion of the film product. Starting the imaging process may further include moving, for example using a conveying device, at least a portion of a film product comprising a single layer of film having a width dimension and a length dimension in a first direction parallel to the length dimension, the first direction parallel to a direction of manufacturing used to manufacture the film product.

After starting the imaging process, apparatus 114 may be triggered to capture image data for a plurality of widthwise image areas of the film product (block 192). Method 190 further includes analyzing the captured data from the image areas to detect the presence of any MDL defects in the film product within the image area (block 193). Analysis of the image data may include analysis using any of the techniques and/or methods described throughout this disclosure, and/or any equivalents thereof, to detect the presence of MDL defects using the capture image data.

Methods 190 may further include displaying in the captured image data for the film product (block 194). Displaying the captured image data at may include displaying the captured image data in real time. Display of the captured image data is not limited to any particular format or type of display, and may include any type of graphical display of information, including display of graphical information as illustrated and described with respect to nay of FIGS. 12A, 12B, and 13.

Referring again to FIG. 15, following capture of image data for the image area associated with the position of apparatus 114, methods 190 may determine whether the image processing has been completed (block 195). In response to a determination that the imaging process has not been completed, (the “NO” branch extending from block 195), method 190 returns to block 192, wherein system 130 where apparatus 114 continues to capture image data for image areas as the film product continues to be moved in the first direction. The sequence of capturing image data for a new image area associated with the film product may be repeated for a number of cycles. The image data captured for each image area may be analyzed (block 193) and/or displayed (block 194) until system 130 determines that the imaging process has been completed (the “YES” branch extending from block 195).

A determination that the imaging process has been completed may be made based on a determination that the end of the film product being imaged has been reached. In some examples, a determination that the imaging process has been completed may be made based on a determination that a threshold level of MDL defects is being detected by the imaging process of the film product being images. A threshold level of MDL defects being detected may be based on a threshold number of MDL defects being detected within a defined period time, by a level of the severity of the MDL defects being detected, or some combination of the number and the severity level of the detected MDL defects. In response to a determinate that the imaging process has been competed, system 130 ends the imaging process (block 196).

The techniques of this disclosure may be implemented in a wide variety of computing devices, image capturing devices, and various combinations thereof. Any of the described units, modules or components may be implemented together or separately as discrete, but interoperable logic devices. Depiction of different features as modules, devices, or units is intended to highlight different functional aspects and does not necessarily imply that such modules, devices, or units must be realized by separate hardware or software components. Rather, functionality associated with one or more modules, devices, or units may be performed by separate hardware or software components, of integrated within common or separate hardware or software components. The techniques described in this disclosure may be implemented, at least in part, in hardware, software, firmware or any combination thereof. For example, various aspects of the techniques may be implemented within one or more microprocessors, digital signal processors (“DSPs”), application specific integrated circuits (“ASICs”), field programmable gate arrays (“FPGAs”), or any other equivalent integrated or discrete logic circuitry, as well as any combinations of such components, embodied in programmers. The terms “processor,” “processing circuitry,” “controller” or “control module” may generally refer to any of the foregoing logic circuitry, alone or in combination with other logic circuitry, or any other equivalent circuitry, and alone or in combination with other digital or analog circuitry.

For aspects implemented in software, at least some of the functionality ascribed to the systems and devices described in this disclosure may be embodied as instructions on a computer-readable storage medium such as random access memory (“RAM”), read-only memory (“ROM”), non-volatile random access memory (“NVRAM”), electrically erasable programmable read-only memory (“EEPROM”), FLASH memory, magnetic media, optical media, or the like that is tangible. The computer-readable storage media may be referred to as non-transitory. A server, client computing device, or any other computing device may also contain a more portable removable memory type to enable easy data transfer or offline data analysis. The instructions may be executed to support one or more aspects of the functionality described in this disclosure. In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

The following illustrative embodiments describe one or more aspects of the disclosure, including numerous example embodiments that may be used in any combination.

Embodiment 1. A system for inspecting a film product, the system comprising: a light source operable to provide a source of light rays, the system operable to direct the light rays to a film product so that the light rays are incident to a surface of the film product at an angle of incidence, the light rays operable to pass through the film product and to be refracted at an angle of refraction when exiting the film product; an image capturing device operable to generate an image of the film product by capturing a level of light intensity of the light rays exiting the film product in a plurality of image areas, each image area representing a line imaged across the film product, the line having a direction that is perpendicular to a direction of manufacture of the film product; the image capturing device comprising an image sensing array operable to capture, as an electronic signal, variations in a level of light intensity received at the image sensing array for each of the plurality of image areas to generate an image of the film product, the variations in level of light intensity received by the image sensing array resulting from variations in the angle of refraction of the light rays exiting the film product in the image area of the film product where the light rays exited the film product; and an image processing device operable to process the image of the film product to provide an indication of a detection of one or more machine direction line (“MDL”) defects in the film product.

Embodiment 2. The system of embodiment 1, wherein the image processing device is operable to generate a series of image rows across the image of the film product, and for each of the image row, sum the level of light intensities captured in the image across the image row, calculate an average light intensity value for summed values for the image row, and provide the indication of the detection of one or more machine direction lines defects in the film product based at least in part the calculated average light intensity values.

Embodiment 3. The system of embodiments 1 or 2, wherein the image capturing device further comprises: a lens; an aperture; and an image sensing array behind lens and aperture; wherein the lens is operable to receive the refracted light rays and the aperture comprising an opening and an edge, the opening and the edge positioned so that a portion of the light rays when received from an expected angle of refraction are blocked by the edge, and the remaining portion of the light rays at the expected angle of refraction pass through the opening in the aperture and are provided to the light sensing array.

Embodiment 4. The system of any of embodiments 1 to 3, further comprising: a beam splitter operable to receive the light rays provided by the point light source, and to redirect the light rays so that the light rays are incident to the surface of the film product at the non-perpendicular angle of incidence.

Embodiment 5. The system of any of embodiments 1 to 4, further comprising: a converging mirror positioned on a side the film product opposite a side of the film product where the image capturing device is located, the converging mirror operable to reflect the light rays back to a lens of the image capturing device after the light rays have made a first pass through the film product so that the light rays make a second pass through the film product before reaching the image capturing device.

Embodiment 6. The system of any of embodiments 1 to 5, wherein the image capturing device comprises a Charge-Coupled Device (“CCD”) camera.

Embodiment 7. The system of any of embodiments 1 to 6, wherein image processing device is operable to generate an intensity line, the intensity level line comprising a series light intensity values, each light intensity value corresponding to a level of the light intensity captured for one of the image areas, and to provide an indication of a detection of one or more machine direction line defects in the film product if at least one of the levels of light intensities on the intensity line extends above or below a threshold value.

Embodiment 8. The system of any of embodiments 1 to 7, wherein the image processing device is operable to provide an indication of a detection of at least one machine direction line defect having a dimension of about 100 nanometers or greater.

Embodiment 9. The system of any of embodiments 1 to 8, wherein the image processing device comprises a display operable for displaying the captured image and image information generated by processing the captured image of the film product.

Embodiment 10. A method comprising: transmitting light from a point light source through a film product, the light refracted at an angle of refraction when passing through and then exiting the film product; directing the refracted light to an edge of an opening of an aperture, and blocking, by the edge, a portion of the refracted light from passing through the opening while allowing the remaining portion of the refracted light to pass though the opening of the aperture and be received at an image sensing array when the angle of refraction of the light received at the focal point is an expected angle of refraction; capturing, by an image sensing array, an electronic signal corresponding to a variation of a level of light intensity received by the image sensing array for each of a plurality of image areas of the film product, each of the plurality of image areas corresponding to an imaged line on the film product having a direction that is perpendicular to a direction of manufacturing used to manufacture the film product, the variations in level of light intensity received by the image sensing array resulting from variations in the angle of refraction of the light exiting the film product in the plurality of image areas of the film product; and analyzing the image to detect the presence of one or more machine direction lines in the film product.

Embodiment 11. The method of embodiment 10, wherein blocking by the edge includes: receiving the refracted light at the focal point, the refracted light having an angle of refraction that is different from the expected angel of refraction; blocking a portion of the refracted light that is a different amount of the refracted light than would be blocked when receiving the refracted light at the expected angle of refraction; and allowing a remaining unblocked portion of the refracted light to pass though the opening of the aperture, and receiving the remaining unblocked portion of the refracted light at an image sensing array.

Embodiment 12. The method of either of embodiments 10 or 11, wherein the different amount of the refracted light that is blocked is substantially all of the refracted light received.

Embodiment 13. The method of either of embodiments 10 or 11, wherein the different amount of the refracted light that is blocked is an amount of the refracted light that is less than the amount of refracted light that would be blocked if the refracted light were refracted at the expected angle of refraction.

Embodiment 14. The method of any of embodiments 10 to 13, wherein transmitting light from a point light source through a film product comprises: directing the light from the point light source to a beam splitter; redirecting the light, by the beam splitter, to the film product for a first pass through the film product, and redirecting, by a converging mirror, the light back for a second pass through the film product.

Embodiment 15. The method of any of embodiments 10 to 14, further comprising; moving the film product in the direction that is perpendicular to a direction of manufacturing used to manufacture the film product to sequentially bring each of the plurality of image areas into an area of the film product currently being imaged; imaging the image areas of the film product; and mapping the imaged areas of the film product to the corresponding image captured for a portion of the film product that corresponds to the imaged area.

Embodiment 16. The method of any of embodiments 10 to 15, further comprising: obtaining a test sample of the film product by removing a crosswise strip of a film product from a web; coupling a first width edge of the test sample to a second widthwise edge of the test sample to form the test sample into a continuous loop; moving the continuous loop of the test sample through an area where the transmitted light from a point light source is being provided to the film product in the direction that is perpendicular to the direction of manufacture of the film product from which the test sample was removed.

Embodiment 17. The method of any of embodiments 10 to 16, wherein analyzing the image to detect the presence of machine direction lines includes quantifying a severity of a detected machine direction line.

Embodiment 18. The method of any of embodiments 10 to 17, wherein analyzing the image to detect the presence of the machine direction lines in film product includes determining a pass/fail status for the film product based on quantifying image information included in the image generated from the film product, and comparing the quantified image information to one or more threshold values.

Embodiment 19. The method of any of embodiments 10 to 18, wherein analyzing the image to detect the presence of machine direction lines in the film product comprising detecting machine direction lines in the film product having a dimension of 100 nanometers or greater.

Embodiment 20. A method of calibrating a film product inspection system comprising: transmitting, from a point light source, without passing the light through a film product, the light to a reflective surface at an angle that corresponds to an expected angle of refraction, the light reflected at an angle of refraction equal to an expected angle of refraction the light would be refracted at if the light passed through and then exited a film product to generate a refracted light exiting the film at the expected angle of refraction; directing, by a reflective surface and without passing the reflected light through a film product, the light to a focal point behind a lens; positioning an edge at the focal point so that a predetermined portion of the reflected light is blocked by the edge, and a remaining portion of the reflected light passes the edge through an opening adjacent to the edge; and adjusting the position of the edge so that the remaining portion of the reflected light passing the edge through the opening in the aperture is received at an image sensing array in a level that generates an electronic signal in image sensing array corresponding to a predetermined level of light intensity.

Embodiment 21. A method for capturing image data associated with a film product, the method comprising: moving, by a conveying device, at least a portion of a film product comprising a single layer of film having a width dimension and a length dimension in a first direction parallel to the length dimension, the first direction parallel to a direction of manufacturing used to manufacture the film product; imaging, by an image capturing device, the portion of the film product while moving the portion of the film product, wherein imaging the portion of the film product comprises capturing a level of light intensity of light rays exiting the film product in each of a plurality of image areas within the portion of the film to generate image data for each of the image areas, each of the image area comprising an image line; and analyzing, by an image processing device comprising processing circuitry, the image data for each of the image areas in real time to detect the presence of one or more machine direction lines in the film product.

Embodiment 22. The method of embodiment 21, wherein imaging the portion of the film product further comprises: transmitting light from a point light source through the portion of the film product, the light refracted at an angle of refraction when passing through and then exiting the portion of the film product; directing the refracted light to an edge of an opening of an aperture, and blocking, by the edge, a portion of the refracted light from passing through the opening while allowing the remaining portion of the refracted light to pass though the opening of the aperture and be received at an image sensing array when the angle of refraction of the light received at the focal point is an expected angle of refraction; capturing, by the image sensing array, an electronic signal corresponding to a variation of a level of light intensity received by the image sensing array for each of the plurality of image areas of the portion of the film product, the variations in level of light intensity received by the image sensing array resulting from variations in the angle of refraction of the light exiting the film product in the plurality of image areas of the film product.

Embodiment 23. The method of embodiment 21, wherein imaging the portion of the film product while moving the portion of the film product further comprises: positioning the image capturing device so that each of the plurality of image areas comprises an image line having an image line length that is parallel to the length dimension of the portion of the film product and is perpendicular to the width dimension of the portion of the film product; and after imaging any one of the plurality of image areas, repositioning the image capturing device relative to the width dimension of the portion of the film product so that each of the plurality of image lines fall within one of a plurality of skewed tracks extending across the width dimension of the portion of the film product so that each of the image lines is parallel to one another and falls within a given one of the skewed tracks.

Embodiment 24. The method of embodiment 21, wherein imaging the portion of the film product while moving the portion of the film product further comprises: positioning the image capturing device so that each of the plurality of image areas comprises an image line having an image line length that is perpendicular to the length dimension of the portion of the film product and is parallel to the width dimension of the portion of the film product so that the image line length extends across the entirety of the width dimension of the portion of the film product; and triggering the image capturing device to image an image area within the portion of the film product so that each of the plurality of image lines is parallel to one another, extends across the entire width dimension of the portion of the film product, and are spaced apart from one another relative to the length dimension of the portion of the film product.

Embodiment 25. The method of any of embodiments 21, 22, 23, or 24, further comprising: generating, by the image processing device, graphical information in real time comprising a graphical indication of a detection of one or more machine direction line defects in the portion of the film product; and displaying the graphical information on a display device.

Embodiment 26. The method of embodiment 25, wherein the image processing device is configured to provide an indication of a detection of a machine direction line defect having a dimension of about 100 nanometers or greater.

Embodiment 27. The method of any of embodiments 21, 22, 23, 24, or 25, wherein analyzing the image data further comprises: mapping the image areas of the portion of the film product to generate graphical information corresponding to one or more locations of any detected machine direction line defects relative to the width dimension and the length dimension of the film product.

Embodiment 28. A system for capturing image data associated with a film product, the system comprising: a conveying device configured to move at least a portion of the film product in a first direction parallel to a length dimension of the film product, the first direction parallel to a direction of manufacturing used to manufacture the film product, the portion of the film product comprising a single layer of film having a width dimension that is perpendicular to the length dimension; an image capturing device configured to image the portion of the film product while the portion of the film product is moving in the first direction, the image capturing device configured to image the portion of the film product by capturing a level of light intensity of light rays exiting the film in each of a plurality of image areas within the portion of the film product to generate image data for each of the image areas, each of the image area comprising an image line; an image processing device comprising processing circuitry and configured to analyze the image data for each of the image area in real time to detect the presence of one or more machine direction lines in the film product.

Embodiment 29. The system of embodiment 28, further comprising: a light source configured to provide a source of light rays, the system configured to direct the light rays to the portion of the film product so that the light rays are incident to a surface of the film product at an angle of incidence, the light rays configured to pass through the film product and to be refracted at an angle of refraction when exiting the film product; the image capturing device comprising an image sensing array configured to capture, as an electronic signal, variations in a level of light intensity received at the image sensing array for each of the plurality of image areas to generate an image of the film product, the variations in level of light intensity received by the image sensing array resulting from variations in the angle of refraction of the light rays exiting the film product in the image area of the film product where the light rays exited the film product.

Embodiment 30. The system of embodiment 28, further comprising: positioning the image capturing device so that each of the plurality of image areas comprises an image line having an image line length that is parallel to the length dimension of the portion of the film product and is perpendicular to the width dimension of the portion of the film product; and the image capturing device configured to be repositioned relative to the width dimension of the portion of the film product after imaging any one of the plurality of image areas so that each of the plurality of image lines fall within one of a plurality of skewed tracks extending across the width dimension of the portion of the film product, wherein each of the image lines is parallel to one another and falls within a given one of the skewed tracks.

Embodiment 31. The system of embodiment 28, further comprising: positioning the image capturing device so that each of the plurality of image areas comprises an image line having an image line length that is perpendicular to the length dimension of the portion of the film product and is parallel to the width dimension of the portion of the film product so that the image line length extends across the entirety of the width dimension of the portion of the film product; and the image capturing device configured to be triggered to image an image area within the portion of the film product so that each of the plurality of image lines are parallel to one another, extend across the entire width dimension of the portion of the film product, and are spaced apart from one another relative to the length dimension of the portion of the film product.

Embodiment 32. The system of any of embodiments 28, 29, 30, or 31, wherein the image processing device is further configured to: generate graphical information in real time comprising a graphical indication of a detection of one or more machine direction line defects in the portion of the film product; the system further comprising a display device configured to display the graphical information.

Embodiment 33. The system of embodiment 32, wherein the image processing device is configured to provide an indication of a detection of a machine direction line defect having a dimension of about 100 nanometers or greater.

Embodiment 34. The system of any of embodiments 28, 29, 30, 31, or 32 wherein the image processing device is configured to map the image areas of the portion of the film product to generate graphical information corresponding to one or more locations of any detected machine direction line defects relative to the width dimension and the length dimension of the film product.

Various aspects of this disclosure have been described. These and other aspects are within the scope of the following claims.

1. A system for inspecting a film product, the system comprising:
a light source operable to provide a source of light rays, the system operable to direct the light rays to a film product so that the light rays are incident to a surface of the film product at a non-perpendicular angle of incidence, the light rays operable to pass through the film product and to be refracted at an angle of refraction when exiting the film product;
an image capturing device operable to generate an image of the film product by capturing a level of light intensity of the light rays exiting the film product in a plurality of image areas, each image area representing a line imaged across the film product, the line having a direction that is perpendicular to a direction of manufacture of the film product;
the image capturing device comprising an image sensing array operable to capture, as an electronic signal, variations in a level of light intensity received at the image sensing array for each of the plurality of image areas to generate an image of the film product, the variations in level of light intensity received by the image sensing array resulting from variations in the angle of refraction of the light rays exiting the film product in the image area of the film product where the light rays exited the film product; and
an image processing device operable to process the image of the film product to provide an indication of a detection of one or more machine direction line (MDL) defects in the film product.

2. The system of claim 1, wherein the image processing device is operable to generate a series of image rows across the image of the film product, and for each of the image row, sum the level of light intensities captured in the image across the image row, calculate an average light intensity value for summed values for the image row, and provide the indication of the detection of one or more machine direction lines defects in the film product based at least in part the calculated average light intensity values.

3. The system of claim 1, wherein the image capturing device further comprises:
a lens;
an aperture; and
an image sensing array behind the lens and the aperture;
wherein the lens is operable to receive the refracted light rays and the aperture comprising an opening and an edge, the opening and the edge positioned so that a portion of the light rays when received from an expected angle of refraction are blocked by the edge, and the remaining portion of the light rays at the expected angle of refraction pass through the opening in the aperture and are provided to the light sensing array.

4. The system of claim 1, further comprising:
a beam splitter operable to receive the light rays provided by the point light source, and to redirect the light rays so that the light rays are incident to the surface of the film product at the non-perpendicular angle of incidence.

5. The system of claim 1, further comprising:
a converging mirror positioned on a side the film product opposite a side of the film product where the image capturing device is located, the converging mirror operable to reflect the light rays back to a lens of the image capturing device after the light rays have made a first pass through the film product so that the light rays make a second pass through the film product before reaching the image capturing device.

6. The system of claim 1, wherein the image capturing device comprises a Charge-Coupled Device (“CCD”) camera.

7. The system of claim 1, wherein image processing device is operable to generate an intensity line, the intensity level line comprising a series light intensity values, each light intensity value corresponding to a level of the light intensity captured for one of the image areas, and to provide an indication of a detection of one or more machine direction line defects in the film product if at least one of the levels of light intensities on the intensity line extends above or below a threshold value.

8. The system of claim 1, wherein the image processing device is operable to provide an indication of a detection of at least one machine direction line defect having a dimension of about 100 nanometers or greater.

9. The system of claim 1, wherein the image processing device comprises a display operable for displaying the captured image and image information generated by processing the captured image of the film product.

10. A method comprising:
transmitting light from a point light source through a film product, the light refracted at an angle of refraction when passing through and then exiting the film product;
directing the refracted light to an edge of an opening of an aperture, and blocking, by the edge, a portion of the refracted light from passing through the opening while allowing the remaining portion of the refracted light to pass though the opening of the aperture and be received at an image sensing array when the angle of refraction of the light received at the focal point is an expected angle of refraction;
capturing, by an image sensing array, an electronic signal corresponding to a variation of a level of light intensity received by the image sensing array for each of a plurality of image areas of the film product, each of the plurality of image areas corresponding to an imaged line on the film product having a direction that is perpendicular to a direction of manufacturing used to manufacture the film product, the variations in level of light intensity received by the image sensing array resulting from variations in the angle of refraction of the light exiting the film product in the plurality of image areas of the film product; and
analyzing the image to detect the presence of one or more machine direction lines in the film product.

11. The method of claim 10, wherein blocking by the edge includes:
receiving the refracted light at the focal point, the refracted light having an angle of refraction that is different from the expected angel of refraction;
blocking a portion of the refracted light that is a different amount of the refracted light than would be blocked when receiving the refracted light at the expected angle of refraction;
allowing a remaining unblocked portion of the refracted light to pass though the opening of the aperture, and
receiving the remaining unblocked portion of the refracted light at an image sensing array.

12. The method of claim 11, wherein the different amount of the refracted light that is blocked is substantially all of the refracted light received.

13. The method of claim 11, wherein the different amount of the refracted light that is blocked is an amount of the refracted light that is less than the amount of refracted light that would be blocked if the refracted light were refracted at the expected angle of refraction.

14. The method of claim 10, wherein transmitting light from a point light source through a film product comprises:
directing the light from the point light source to a beam splitter;
redirecting the light, by the beam splitter, to the film product for a first pass through the film product; and
redirecting, by a converging mirror, the light back for a second pass through the film product.

15. The method of claim 10, further comprising;
moving the film product in the direction that is perpendicular to a direction of manufacturing used to manufacture the film product to sequentially bring each of the plurality of image areas into an area of the film product currently being imaged;
imaging the image areas of the film product; and
mapping the imaged areas of the film product to the corresponding image captured for a portion of the film product that corresponds to the imaged area.

16. The method of claim 10, further comprising
obtaining a test sample of the film product by removing a crosswise strip of a film product from a web;
coupling a first width edge of the test sample to a second widthwise edge of the test sample to form the test sample into a continuous loop; and
moving the continuous loop of the test sample through an area where the transmitted light from a point light source is being provided to the film product in the direction that is perpendicular to the direction of manufacture of the film product from which the test sample was removed.

17. The method of claim 10, wherein analyzing the image to detect the presence of machine direction lines includes quantifying a severity of a detected machine direction line.

18. The method of claim 10, wherein analyzing the image to detect the presence of the machine direction lines in film product further comprises:
determining a pass/fail status for the film product based on quantifying image information included in the image generated from the film product; and
comparing the quantified image information to one or more threshold values.

19. The method of claim 10, wherein analyzing the image to detect the presence of machine direction lines in the film product comprises detecting machine direction lines in the film product having a dimension of 100 nanometers or greater.

20. A method of calibrating a film product inspection system comprising:
transmitting, from a point light source, without passing the light through a film product, the light to a reflective surface at an angle that corresponds to an expected angle of refraction, the light reflected at an angle of refraction equal to an expected angle of refraction the light would be refracted at if the light passed through and then exited a film product to generate a refracted light exiting the film at the expected angle of refraction;
directing, by a reflective surface and without passing the reflected light through a film product, the light to a focal point behind a lens;
positioning an edge at the focal point so that a predetermined portion of the reflected light is blocked by the edge, and a remaining portion of the reflected light passes the edge through an opening adjacent to the edge; and
adjusting the position of the edge so that the remaining portion of the reflected light passing the edge through the opening in the aperture is received at an image sensing array in a level that generates an electronic signal in image sensing array corresponding to a predetermined level of light intensity.
